(19) United States
(12) Patent Application Publication
(10) Pub. No.: US 2026/0304538 A1
(43) Pub. Date: Oct. 1, 2026

(54) OPERATING WIRELESS DEVICES IN MULTIPLE TYPES OF NETWORKS

(71) Applicant: Texas Instruments Incorporated, Dallas, TX (US)

(72) Inventors: Kumaran Vijayasankar, Allen, TX (US); Caleb Jackson Overbay, Dallas, TX (US)

(21) Appl. No.: 19/435,205

(22) Filed: Dec. 29, 2025

Related U.S. Application Data
(60) Provisional application No. 63/778,767, filed on Mar. 27, 2025.

(51) Int. Cl. H04W 76/25; H04W 4/23; H04W 24/08

(52) U.S. Cl. CPC H04W 76/25; H04W 4/23; H04W 24/08

(57) ABSTRACT

An example device includes a first transceiver for a first type of network. The device includes a second transceiver for a second type of network. The device includes at least one processor core coupled to the first transceiver and the second transceiver, the at least one processor core configurable to, responsive to determining that the device may operate in the first type of network and the second type of network: receive, via the first transceiver, a message of the first type of network; and transmit, via the second transceiver, the message.

### CROSS-REFERENCE TO RELATED APPLICATION

This patent application claims the benefit of and priority to U.S. Provisional Patent Application No. 63/778,767 filed Mar. 27, 2025, which Application is hereby incorporated herein by reference in its entirety.

### TECHNICAL FIELD

This description relates generally to wireless communications and, more particularly, to operating wireless devices in multiple types of networks.

### BACKGROUND

Metering is the process of measuring an amount of a resource consumed by a residence, business, or industrial facility. Meters can be implemented by electromechanical meters or digital smart meters. Smart meters (such as electricity meters, water meters, gas meters, thermal energy meters, steam meters, temperature meters, etc.) wirelessly transmit real-time usage data to utilities and support better resource management, resource infrastructure efficiency, and customer awareness of resource consumption. Electricity meters (e-meters) measure the amount of electricity consumed, gas meters measure the amount of gas consumed, and water meters measure the amount of water consumed.

### SUMMARY

For systems, methods, apparatus, and articles of manufacture for operating wireless devices in multiple types of networks, an example device includes a first transceiver for a first type of network. The device includes a second transceiver for a second type of network. The device includes at least one processor core coupled to the first transceiver and the second transceiver, the at least one processor core configurable to, responsive to determining that the device may operate in the first type of network and the second type of network: receive, via the first transceiver, a message of the first type of network; and transmit, via the second transceiver, the message. Other examples are described.

For systems, methods, apparatus, and articles of manufacture for operating wireless devices in multiple types of networks, an example meter includes a transceiver. The meter includes at least one processor core coupled to the transceiver, the at least one processor core configurable to: monitor, via the transceiver, a first device for periodic heartbeat messages; and responsive to failing to receive a threshold number of the heartbeat messages, transmit, via the transceiver, a non-configured advertisement to join a network via a second device. Other examples are described.

For systems, methods, apparatus, and articles of manufacture for operating wireless devices in multiple types of networks, an example method includes responsive to determining that a device is capable of operating in a first type of network and a second type of network: receiving, via a second transceiver over the second type of network, a message to manage the first type of network; and transmitting, via a first transceiver over the first type of network, the message to a participant device of the first type of network responsive to determining that the message includes a device address assigned to the participant device. Other examples are described.

### BRIEF DESCRIPTION OF THE DRAWINGS

FIG. 1 is a block diagram of an example environment including example meters managed by an example utility entity.

FIG. 2 is a block diagram of an example implementation of an example meter that can implement any of the meters of FIG. 1.

FIG. 3 is a flowchart representative of example operations that may be performed by at least one of software, firmware, or hardware that is at least one of executed, instantiated, or implemented by the meter of FIG. 2 to perform an automated discovery protocol for how the meter is to operate in a first type of network.

FIG. 4 is a block diagram of two example instances of a first type of network formed by a fleet of example devices.

FIGS. 5A and 5B (collectively “FIG. 5”) is a flowchart representative of example operations that may be performed by at least one of software, firmware, or hardware that is at least one of executed, instantiated, or implemented by the meter of FIG. 2 to operate as a setup management device.

FIG. 6 is a flowchart representative of example operations that may be performed by at least one of software, firmware, or hardware that is at least one of executed, instantiated, or implemented by the meter of FIG. 2 to operate as a participant device.

FIG. 7 is a sequence diagram depicting example operations of a first example device depending on connectivity to a second example device in a second type of network.

FIG. 8 is a block diagram depicting how participant devices of the second instance of the first type of network of FIG. 4 respond to loss of connectivity between the device operating as the setup management device for the second instance and the second type of network.

FIG. 9 is a flowchart representative of example operations that may be performed by at least one of software, firmware, or hardware that is at least one of executed, instantiated, or implemented by the meter of FIG. 2 to respond to loss of connectivity with a second type of network when operating as a setup management device.

FIGS. 10A and 10B (collectively “FIG. 10”) is a flowchart representative of example operations that may be performed by at least one of software, firmware, or hardware that is at least one of executed, instantiated, or implemented by the meter of FIG. 2 to rejoin a first type of network when operating as a participant device responsive to a first setup management device losing connectivity with a second type of network.

FIG. 11 is a sequence diagram depicting example operations to respond to a first example device operating as a setup management device losing connectivity with a second type of network.

FIG. 12 is a flowchart representative of example operations that may be performed by at least one of software, firmware, or hardware that is at least one of executed, instantiated, or implemented by the meter of FIG. 2 to respond to loss of connectivity with a participant device when operating as a setup management device.

FIG. 13 is a sequence diagram depicting example operations to respond to a first example device operating as a participant device losing connectivity with a second example device operating as a setup management device.

FIG. 14 is a block diagram of an example intra-device network capable of responding to a service message from an example service device.

FIG. 15 is a flowchart representative of example operations that may be performed by at least one of software, firmware, or hardware that is at least one of executed, instantiated, or implemented by the meter of FIG. 2 to operate in an intra-device network.

FIG. 16 is a sequence diagram depicting example operations of example devices in an intra-device network.

The drawings are not necessarily to scale. Generally, the same reference numbers in the drawing(s) and this description refer to the same or similar (in terms of at least one of functional or structural) features or parts. Although the drawings show regions with clean lines and boundaries, some or all of these lines and boundaries may be idealized. In reality, the boundaries or lines may be unobservable, blended or irregular.

### DETAILED DESCRIPTION

Metering is the process of measuring an amount of a resource consumed by a residence, business, or industrial facility. For example, e-metering involves monitoring of power consumption though e-meters. In many places, cellular technology has been used to transmit real-time usage data from smart meters to utilities. For example, application software of meters causes wireless transmission of Device Language Message Specification (DLMS)/Companion Specification for Energy Metering (COSEM) formatted packets to utilities through a cellular connection. Utilizing cellular technology simplifies data collection from and maintenance of meters. For example, because a cellular-connected meter is remotely accessible, manual interaction with the meter can be minimized which simplifies data collection from and maintenance of the meter.

However, there are many cases in which the cellular coverage of a meter may not be sufficient due to the placement of the meter, distance between the meter and a cellular tower, or other reasons that could prevent the meter from obtaining or maintaining cellular connectivity. In such cases, a meter becomes unreachable from a network connectivity perspective. If a smart meter that uses cellular technology to wirelessly transmit data loses cellular connectivity, manual interaction with the meter is required to collect data. When manually collecting data, a meter can be physically difficult to access. For example, meters in basements, in backyards with walls or fences, in sewers, etc. can be physically difficult to access.

Advantageously, examples described herein adjust the role of a meter in a first type of network responsive to connectivity of the meter to a second type of network. As such, meters in the first type of network (such as a Bluetooth Low Energy (BLE) mesh, a Modbus, a Thread, a low-power, wide-area network (LPWAN), a Bluetooth, etc. network) can advantageously bridge gaps in coverage provided by a second type of network (such as a cellular, a wireless fidelity (Wi-Fi), a Wi-Fi smart ubiquitous network (Wi-SUN), a Zigbee, a power-line communication (PLC), a Matter, etc. network). For example, responsive to a meter having access to both a first type of network (such as a BLE mesh network) and a second type of network (such as a cellular network), the meter operates as both a setup management device for and a participant device of an instance of the first type of network. As a setup management device (also referred to as a provisioner device), the meter provisions and adds participant devices to an instance of the first type of network. After the instance of the first type of network is set up, the setup management device serves as a gateway device between the instance of the first type of network and the second type of network where the gateway device routes communications between participant devices of the instance of the first type of network and a headend server of a utility entity.

In examples described herein, responsive to a meter having access to a first type of network (such as a BLE mesh network) but not having access to a second type of network (such as a cellular network), the meter operates as a non-setup management participant device of an instance of the first type of network. As a non-setup management participant device, a meter discovers a setup management device that is physically proximate to the meter. After discovering a setup management device, the non-setup management participant device joins an instance of the first type of network provisioned (or configured) by the setup management device. As a participant device (both a setup management participant device and a non-setup management participant devices), the participant device reports metering data to a headend server of a utility entity through the setup management device.

Also, as a non-setup management participant device, the non-setup management participant device serves as a relay device in an instance of the first type of network (such as a BLE mesh network). Relay devices improve robustness of instances of the first type of network and extend the coverage of instances of the first type of network for both message forwarding and device provisioning. As a relay device, a meter forwards communications to and from a setup management device of an instance of the first type of network for other participant devices of the instance of the first type of network. For example, the other participant devices may be further away from the setup management device than the relay device. In this manner, participant devices (also referred to as mesh devices) of an instance of the first type of network route communications to and from a setup management device of the instance of the first type of network and the setup management device routes the communications to and from a headend server of a utility entity. Thus, each meter of an instance of the first type of network is connected to the second type of network by a setup management device and can be remotely accessed by a headend server of a utility entity.

Examples described herein also provide an alternative wireless data path to access a meter that loses connectivity to the second type of network. For example, responsive to a setup management device (such as a cellular-connected meter) losing connectivity to the second type of network, the setup management device can rejoin the first type of network as a participant device and connect to another setup management device (such as another cellular-connected meter). Also, participant devices accessing a headend server via the setup management device can connect to another setup management device. Thus, described systems, methods, apparatus, and articles of manufacture advantageously mitigate gaps in network coverage, increase the range from which a physically inaccessible device can be connected, simplify data retrieval from meters, and support large network sizes (for example, greater than or equal to 100 devices). Described examples also integrate with systems utilizing existing technology (such as DLMS/COSEM).

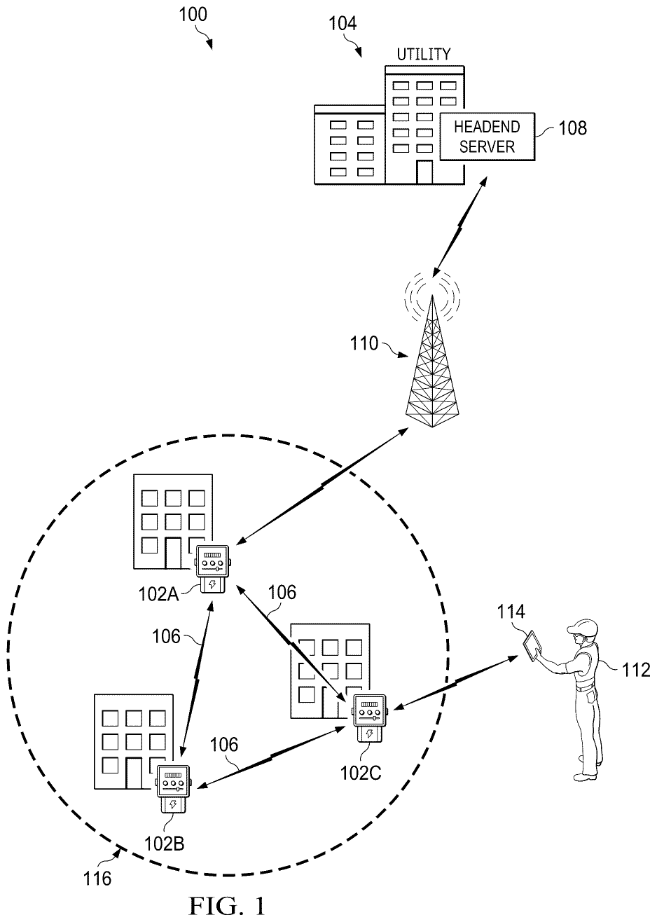

FIG. 1 is a block diagram of an example environment 100 including example meters 102A-102C managed by an example utility entity 104. In the example of FIG. 1, the meters 102A-102C are smart meters in a monitoring environment. For example, each of the meters 102A-102C is a smart meter that monitors the amount of a resource consumed at an individual location in the monitoring environment. Smart meters wirelessly transmit real-time usage data to utilities and support better resource management, resource infrastructure efficiency, and customer awareness of resource consumption. In the example of FIG. 1, each of the meters 102A-102C is a smart e-meter that monitors electricity consumption. In additional or alternative examples, one or more of the meters 102A-102C is a different type of meter such as a gas meter or a water meter.

In the illustrated example of FIG. 1, the monitoring environment is a residential neighborhood and each of the meters 102A-102C is deployed at an individual residence. In some examples, the monitoring environment is an apartment building and each of the meters 102A-102C is associated with an individual apartment. Also or alternatively, the monitoring environment is a business or industrial facility. In the example of FIG. 1, the meters 102A-102C are in communication over an example first type of network 106.

In the illustrated example of FIG. 1, the first type of network 106 is a BLE mesh network. A BLE mesh network is a network that utilizes the BLE mesh networking standard. The BLE mesh networking standard is based on the BLE standard and is designed for decentralized, scalable networking via managed flooding. For example, the BLE mesh networking standard allows for many-to-many communication over Bluetooth radio. In a BLE mesh network, nodes of the BLE mesh network relay messages between source addresses and destination addresses. The BLE mesh networking standard supports relaying communications over ranges between 100 and 1,000 meters.

In the illustrated example of FIG. 1, the utility entity 104 includes an example headend server 108 that is in communication with at least one of the meters 102A-102C over an example second type of network 110. In the example of FIG. 1, the utility entity 104 is an electrical utility. Also or alternatively, the utility entity 104 is a different type of utility such as a water utility or a gas utility. In the example of FIG. 1, the headend server 108 is a server that accesses, processes, and causes transmission of communications to and from at least one of the meters 102A-102C over the second type of network 110. In the example of FIG. 1, the second type of network 110 is a cellular network such as a fourth generation (4G) long term evolution (LTE) cellular network, a fifth generation (5G) cellular network, or a sixth generation (6G) cellular network.

In additional or alternative examples, the first type of network 106 is a different type of network. Different types of networks that can implement the first type of network include any type of network that can form an independent sub-network that can bridge to another type of network to get backend internet. Examples of different types of networks that can implement the first type of network include Zigbee, Wi-SUN, Modbus, Matter, Thread, LPWAN, Bluetooth, Wi-Fi, and PLC. In some examples, the second type of network 110 is a different type of network. Different types of networks that can implement the second type of network include any type of network that can provide access to backend internet. Examples of different types of networks that can implement the second type of network include Wi-SUN, Zigbee, Wi-Fi, PLC, and Matter. As described above, a Zigbee, Wi-SUN, Wi-Fi, PLC, or Matter network can implement either of the first type of network or the second type of network depending on what role the network is expected to play in the environment 100.

In the illustrated example of FIG. 1, the headend server 108 accesses metering data for each of the meters 102A-102C over the second type of network 110. As such, the headend server 108 can monitor electricity consumption by each of the residences at which the meters 102A-102C are deployed. In the example of FIG. 1, the headend server 108 also accesses meter status data for each of the meters 102A-102C over the second type of network 110. For example, meter status data identifies whether a meter is connected to the first type of network 106. In the example of FIG. 1, responsive to at least one of the meters 102A-102C becoming disconnected from the first type of network 106, the headend server 108 schedules maintenance of the at least one of the meters 102A-102C as described herein.

In the illustrated example of FIG. 1, each of the meters 102A-102C includes at least one of software, firmware, or hardware based on a custom model defined for dynamic role selection and operation in the first type of network 106. For example, the BLE mesh networking standard includes models that define operation of a device in specific scenarios. For example, the BLE mesh networking standard includes a configuration server model, a configuration client model, a health model (including a health server model and a health client model), and a remote provisioning model. The BLE mesh networking standard also permits users to define custom models specifying application layer operations that are not part of the BLE mesh networking standard. For example, a user can define a custom model that specifies operation of a device in a user-defined scenario.

As described above, each of the meters 102A-102C includes at least one of software, firmware, or hardware based on the custom model defined for dynamic role selection and operation in the first type of network 106. In the example of FIG. 1, each of the meters 102A-102C is to adapt its role in the first type of network 106 based on connectivity of each of the meters 102A-102C to the second type of network 110. Responsive to adaptive a role in the first type of network 106, each of the meters 102A-102C performs that role in the first type of network 106. As such, meters in the first type of network 106 can advantageously bridge gaps in coverage provided by the second type of network 110. In example described herein, responsive to a meter having access to the first type of network 106 and having access to the second type of network 110, the meter operates as a setup management device for and a participant device of the first type of network 106.

In the illustrated example of FIG. 1, a first example meter 102A has access to both the first type of network 106 and the second type of network 110. As such, the meter 102A operates as both a setup management device for and a participant device of the first type of network 106. As a setup management device, the meter 102A configures and adds participant devices to the first type of network 106. In the example of FIG. 1, the meter 102A may be portable or fixed. After setting up an instance of the first type of network 106, a setup management device serves as a gateway device between the instance of the first type of network 106 and the second type of network 110. For example, after the first type of network 106 is set up, the meter 102A routes messages (for example, is to route messages) between participant devices of the first type of network 106 and the headend server 108 of the utility entity 104.

In examples described herein, responsive to a meter having access to the first type of network 106 but not having access to the second type of network 110, the meter operates as a non-setup management participant device of an instance of the first type of network 106. For example, responsive to a second example meter 102B having access to the first type of network 106 but not having access to the second type of network 110, the meter 102B operates as a non-setup management participant device of the first type of network 106. In the example of FIG. 1, a non-setup management participant device is a device that is capable of being provisioned or configured by a setup management device. For example, as a non-setup management participant device, the meter 102B discovers a setup management device that is physically proximate to the meter 102B. In the example of FIG. 1, the meter 102B discovers the meter 102A. After discovering a setup management device, a non-setup management participant device joins an instance of the first type of network 106 provisioned (or configured) by the setup management device. For example, after discovering the meter 102A, the meter 102B joins the first type of network 106 as a participant device.

In examples described herein, a participant device (both a setup management participant device and a non-setup management participant devices) reports metering data to a headend server of a utility entity through the setup management device. For example, the meter 102A reports metering data collected by the meter 102A to the headend server 108 via the second type of network 110. Also, for example, the meter 102B sends metering data to the meter 102A (for example, the setup management device of the first type of network 106) and the meter 102A forwards the metering data of the meter 102B to the headend server 108 via the second type of network 110.

In examples described herein, a participant device (both a setup management participant device and a non-setup management participant devices) also serves as a relay device between other participant devices in an instance of the first type of network 106. In the example of FIG. 1, a third example meter 102C may be further away from a source or destination meter than at least one of the meter 102A or the meter 102B. As such, for communications from the meter 102C, at least one of the meter 102A or the meter 102B receives and retransmits the communications towards destination meters. Also, for communications addressed to the meter 102C, at least one of the meter 102A or the meter 102B receives and retransmits the communications to the meter 102C.

In this manner, participant devices of an instance of the first type of network 106 route communications to and from a setup management device of the instance of the first type of network 106 regardless of whether some of the participant devices are not within range of the setup management device. As such, the setup management device can route communications between a headend server of a utility entity and all participant devices of an instance of the first type of network 106. Thus, in the example of FIG. 1, if the meter 102C does not have access to the second type of network 110 and is not within range of the meter 102A, the meter 102C can still report metering data to and receive control messages from the headend server 108 by way of the meter 102B. For example, the meter 102B receives and retransmits communications between the meter 102C and the meter 102A. As such, the meter 102C can communicate with the headend server 108 despite not having access to the second type of network 110. Thus, each meter of the first type of network 106 is connected to the second type of network 110 by the setup management device of the first type of network 106 (the meter 102A) and can be remotely accessed by the headend server 108 of the utility entity 104.

In some examples, more than one meter in a fleet of meters has connectivity to the second type of network 110. As such, multiple meters may operate as setup management devices and establish respective instances of the first type of network 106. In such examples, responsive to a first setup management device losing connectivity to the second type of network 110 after establishing a first instance of the first type of network 106, participant devices in the first instance of the first type of network 106 can join a second instance of the first type of network 106 established by a second setup management device. For example, if both the meter 102A and the meter 102B have access to the second type of network 110, the meter 102A can establish a first instance of the first type of network 106 and the meter 102B can establish a second instance of the first type of network 106. Thus, responsive to the meter 102A losing connectivity to the second type of network 110, participant devices connected to the first instance of the first type network 106 can join the second instance of the first type of network 106 established by the meter 102B.

As described above, in examples described herein, meters automatically form and self-heal the first type of network 106 without personnel interaction. For example, meters automatically discovery their role in an instance of the first type of network 106 responsive to connectivity to the second type of network 110. Thus, service works are not required to manually set up instances of the first type of network. Also, if a meter loses connectivity to the second type of network 110, a service worker may not need to be dispatched to service the meter. For example, by implementing self-healing as described herein, meters that were reporting metering data through a meter that is now disconnected from the second type of network 110 can redirect their metering data to one or more meters that continue to have connectivity to the second type of network 110. Thus, a fleet of meters can “self-heal” responsive to one or more meters losing connectivity to the second type of network 110 and a service worker does not need to visit a deployment to service a meter that has become disconnected from the second type of network 110.

In some examples, the headend server 108 can schedule maintenance of at least one of the meters 102A-102C as described above. For example, personnel of the utility entity 104 can schedule maintenance for at least one of the meters 102A-102C. In some examples, the headend server 108 can schedule maintenance in an automated manner responsive to a message indicating that a meter has lost connectivity to the first type of network 106. In the example of FIG. 1, maintenance (scheduled or otherwise) of a meter includes an example service person 112 accessing the meter in-person to service the meter. For example, the service person 112 utilizes an example service device 114 to connect to an example intra-device network 116.

In the illustrated example of FIG. 1, the intra-device network 116 (also referred to as an intra-meter network) is a BLE mesh network formed among all the meters of a fleet of meters managed by the utility entity 104 in a particular area. To service a meter, the service person 112 forms a proxy connection between the service device 114 and a proxy device of the intra-device network 116. For example, a proxy connection includes the service device 114 sending a solicitation protocol data unit (PDU) to a proxy device. Also or alternatively, proxy devices can utilize always-on advertisements to advertise the intra-device network 116.

In examples described herein, a proxy device is a non-setup management participant device that can connect to another device via a peer-to-peer wireless communication technology such as BLE. As used herein, a proxy connection refers to a connection between a first device and a proxy device. For example, the proxy connection allows the first device to communicate with a second device utilizing the proxy device as a proxy for the second device. In the example of FIG. 1, each of the meters 102A-102C is a proxy device. Thus, the service device 114 can form a proxy connection with any of the meters 102A-102C provided that the service device 114 is within range of the meters 102A-102C. As described above, each of the meters 102A-102C is also a participant device of the intra-device network 116. Thus, the proxy device to which the service device 114 connects can route communications between the service device 114 and a target device. As such, by using one or more proxy devices and relay devices within the intra-device network 116, examples described herein increase the range from which the service device 114 can access a target device.

Thus, the service person 112 can advantageously access and service any of the meters of the intra-device network 116 even if a meter is physically inaccessible. For example, if the service person 112 is to service the meter 102B but the meter 102B is out-of-range or physically obstructed, the service person 112 can still access and service the meter 102B through, for example, the meter 102C. Provided that the meter 102C is in range of the service device 114, the service person 112 can access the meter 102B, and, more generally, the entirety of the intra-device network 116, through the meter 102C. As such, the service device 114 can at least one of configure, provision, service, or collect data from out-of-range meters through a secure proxy connection. Accordingly, proxy devices facilitate easy access to a fleet of meters via a service device such as a handheld device (for example, a mobile phone).

As described above, in the example of FIG. 1, the intra-device network 116 is a BLE mesh network formed among all the meters of a fleet of meters managed by the utility entity 104 in a particular area. For example, in a residential neighborhood, the intra-device network 116 includes all the meters in the residential neighborhood. Also or alternatively, in an apartment building, the intra-device network 116 includes all the meters in the apartment building. In some examples, the intra-device network 116 and the first type of network 106 include the same devices. For example, if the fleet of meters includes only a single mesh network, then the intra-device network 116 and the first type of network 106 include the same devices. Also or alternatively, if the fleet of meters includes multiple mesh networks, the intra-device network 116 includes more devices than the individual instances of the first type of network 106. In some examples, personnel of the utility entity 104 can elect to implement one or more of the first type of network 106 or the intra-device network 116.

Also, as described above, multiple meters in a fleet of meters may have connectivity to the second type of network 110. In some examples, one of multiple meters connected to the second type of network 110 can be selected or elected to operate as the setup management device for a set of reachable meters. For example, responsive to the meter 102A and the meter 102B both having connectivity to the second type of network 110, one of the meters 102A-102B can be elected or selected to serve as the setup management device for the first type of network 106. By selecting or electing one meter connected to the second type of network 110 to operate as a setup management device, examples described herein reduce the number of instances of the first type of network 106 formed in a fleet of meters, avoid the need for a meter to scan and rejoin another instance of the first type of network 106 when another setup management device loses connectivity to the second type of network 110, and consolidate instances of the first type of network 106 and the intra-device network 116 into a single network.

To select or elect a setup management device, each meter with connectivity to the second type of network 110 advertises to the headend server 108 that the meter has connectivity to the second type of network 110 and can serve as a setup management device for the first type of network 106. Responsive to the location of the meters with connectivity to the second type of network 110 and other information about the meters with connectivity to the second type of network 110, the headend server 108 determines which of the meters with connectivity to the second type of network 110 is to operate as the setup management device for the first type of network 106. For example, responsive to one of the meters with connectivity to the second type of network 110 being out-of-range of a meter that does not have connectivity to the second type of network 110, the headend server 108 disqualifies the meter with connectivity to the second type of network 110 from consideration as the setup management device.

Also or alternatively, to select or elect a setup management device, every meter with connectivity to the second type of network 110 generates a random number (or pseudo-random number) and shares the random number among the other meters with connectivity to the second type of network 110. In some examples, the meters with connectivity to the second type of network 110 select or elect the meter that generated the lowest number among the meters with connectivity to the second type of network 110. Alternatively, the meters with connectivity to the second type of network 110 select or elect a meter that generated the highest number among the meters with connectivity to the second type of network 110. In additional or alternative examples, election or selection techniques are possible.

As described above, examples described herein improve network management when operating over mixed networks (such as cellular and BLE mesh networks). For example, described examples allow for a meter to change its network operation in a first type of network (for example, a BLE mesh network) depending on connectivity to a second type of network (for example, a cellular network). Accordingly, described examples advantageously allow for seamless operation from an overall network perspective. Examples described herein also advantageously handle load balancing of meters with connectivity to the second type of network. Described examples also advantageously allow for flexible operations between remote management and in-person service operation.

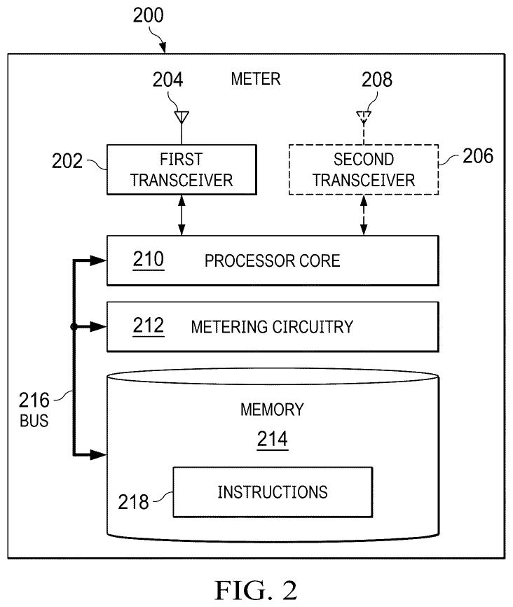

FIG. 2 is a block diagram of an example implementation of an example meter 200 that can implement any of the meters 102A-102C of FIG. 1.

In the illustrated example of FIG. 2, the meter 200 includes a first example transceiver 202 and a first example antenna 204. For example, the transceiver 202 corresponds to a first type of network such as a BLE network and the antenna 204 is tuned for communication via the first type of network. In some examples, the meter 200 includes a second example transceiver 206 and a second example antenna 208. For example, the transceiver 206 corresponds to a second type of network such as a cellular network and the antenna 208 is tuned for communication via the second type of network. Example cellular networks include 4G, 5G, and 6G cellular networks and an example transceiver capable of communicating with a cellular network includes a universal asynchronous receiver transmitter (UART).

In the illustrated example of FIG. 2, the antenna 204 is implemented by a single antenna and the antenna 208 is implemented by a single antenna. In some examples, the meter 200 includes multiple antennas to implement the antenna 204. Also or alternatively, the meter 200 includes multiple antennas to implement the antenna 208. In some examples, the meter 200 includes at least one antenna to facilitate communication between the transceiver 202, the transceiver 206, the first type of network, and the second type of network (e.g., one antenna that facilitates communication between the transceiver 202 and the first type of network as well as between the transceiver 206 and the second type of network). For example, the at least one antenna is tuned to resonate at frequencies corresponding to both the first and second types of networks. Also or alternatively, the meter 200 includes circuitry to isolate the frequencies corresponding to both the first and second types of networks. In some examples, the meter 200 schedules transmission and reception of signals corresponding to the first and second types of networks to avoid at least one of simultaneous communication or interference. In some examples, the first transceiver 202 and the second transceiver 206 are unified in a single transceiver that corresponds to both the first type of network and the second type of network. In such examples, the unified transceiver can be coupled to the antenna 204 and the antenna 208 or can be coupled to at least one antenna that facilitates communication between the unified transceiver and both types of networks as described above.

In the illustrated example of FIG. 2, the meter 200 also includes an example processor core 210, example metering circuitry 212, and an example memory 214. In the example of FIG. 2, the transceiver 202 and the processor core 210 are in communication. In some examples, the transceiver 206 is in communication with the processor core 210. As such, the processor core 210 is coupled to and can communicate via at least one of the transceiver 202 or the transceiver 206. In the example of FIG. 2, the processor core 210, the metering circuitry 212, and the memory 214 are in communication via an example bus 216. For example, the bus 216 is implemented by at least one of an Inter-Integrated Circuit (I2C) bus, a Serial Peripheral Interface (SPI) bus, a Peripheral Component Interconnect (PCI) bus, or a Peripheral Component Interconnect Express (PCIe or PCIE) bus. In additional or alternative examples, the bus 216 can be implemented by any other type of computing or electrical bus.

In the illustrated example of FIG. 2, the processor core 210 is hardware. For example, the processor core 210 is implemented by at least one processor that implements software and support hardware such as control hardware, memory hardware, system hardware, and performance hardware. Examples of the at least one processor include one or more general purpose semiconductor-based electrical circuits programmable with instructions to perform one or more specific functions(s) or operation(s) and including one or more semiconductor-based logic devices (for example, electrical hardware implemented by one or more transistors). Example general purpose semiconductor-based electrical circuits include at least one FPGA, at least one microprocessor, at least one CPU, and at least one microcontroller from any desired family or manufacturer.

Example control hardware includes pipeline control logic and a branch prediction unit. Example memory hardware includes a cache interface and load/store units. Example system hardware includes interrupt and exception handling logic and debug logic Example performance hardware includes clocking and power management circuits and performance monitoring units. In some examples, the processor core 210 is implemented by one or more special purpose electrical circuits (such as, an ASIC) structured to perform specific operation(s) and including one or more semiconductor-based logic devices (for example, electrical hardware implemented by one or more transistors). In the example of FIG. 2, the processor core 210 at least one of executes or instantiates machine-readable instructions as described herein.

In the illustrated example of FIG. 2, the metering circuitry 212 corresponds to a resource to be measured by the meter 200. In the example of FIG. 2, if the meter 200 is an e-meter, then the metering circuitry 212 is structured to monitor at least one of consumption of electric energy, voltage levels, current, or power factor. In some examples, if the meter 200 is a gas meter, the metering circuitry 212 is structured to monitor consumption of gas (such as natural gas or liquefied petroleum gas) responsive to a flow rate of the gas. Also or alternatively, if the meter 200 is a water meter, the metering circuitry 212 is structured to monitor consumption of water responsive to a volume of water consumed or a volume of waste water produced.

In the illustrated example of FIG. 2, the meter 200 includes the memory 214 to record data (such as metering data, heartbeat messages, at least one message from at least one other meter, etc.). In the example of FIG. 2, the memory 214 may be implemented by at least one of a volatile memory (for example, a Synchronous Dynamic Random Access Memory (SDRAM), Dynamic Random Access Memory (DRAM), RAMBUS Dynamic Random Access Memory (RDRAM), etc.) or a non-volatile memory (for example, flash memory). Also or alternatively, the memory 214 may be implemented by one or more double data rate (DDR) memories, such as DDR, DDR2, DDR3, DDR4, DDR5, mobile DDR (mDDR), DDR SDRAM, etc.

In the illustrated example of FIG. 2, the memory 214 may also or alternatively be implemented by one or more mass storage devices such as solid-state disk (SSD) drive(s), Secure Digital (SD) card(s), CompactFlash (CF) card(s), etc. While in the illustrated example the memory 214 is illustrated as a single memory, the memory 214 may be implemented by any number or type(s) of memories. Furthermore, the data stored in the memory 214 may be in any data format such as, for example, binary data, comma delimited data, tab delimited data, structured query language (SQL) structures, etc.

As described above, each meter operating as a setup management device configures a first type of network. For example, the first type of network is a BLE mesh network. For a BLE mesh network, a setup management device assigns a network key and a network identifier (ID) to non-setup management participant devices of the BLE mesh network provisioned by the setup management device. Also, as described above, each meter operating as a non-setup management participant device of the first type of network serves as both a proxy device and a relay device. In the example of FIG. 2, the memory 214 stores machine-readable instructions corresponding to one or more models. For example, models define operation of the meter 200 in specific scenarios.

In the illustrated example of FIG. 2, the memory 214 includes machine-readable instructions corresponding to models defined by the BLE mesh networking standard and one or more custom models described herein. In the example of FIG. 2, the memory 214 includes example instructions 218. For example, the instructions 218 correspond to one or more models defined in the BLE mesh networking standard and/or one or more custom models described herein. Example models defined in the BLE mesh networking standard include the configuration server model, the configuration client model, the health server model, the health client model, and the remote provisioning model. In the BLE mesh networking standard, the remote provisioning model defines how a setup management device can remotely provision a participant device through one or more relay devices. As such, the remote provisioning model provides increased network range by facilitating provisioning of out-of-range devices in an instance of the first type of network. The health client model, the health server model, the configuration client model, the configuration server model, and the remote provisioning model are not described further herein.

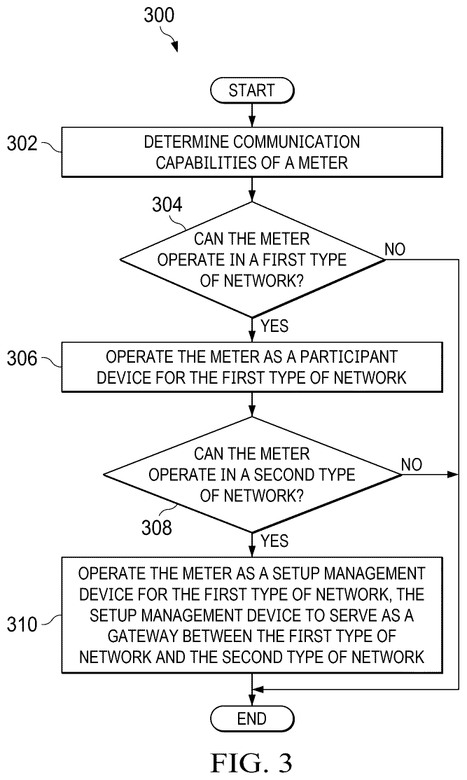

As described above, the instructions 218 correspond to one or more models defined in the BLE mesh networking standard and/or one or more custom models described herein. An example custom model described herein defines operation of the meter 200 as described herein. For example, the custom model can be implemented according to the flowchart(s) of at least one of FIGS. 3, 5, 6, 9, 10, 12, or 15. As described above, a meter can operate as at least one of a setup management device (also referred to as a provisioner) or a participant device (also referred to as a mesh device or mesh node) in a first type of network depending on connectivity of the meter to a second type of network.

For example, as a setup management device, the meter 200 configures an instance of the first type of network. After configuring the first type of network, the meter 200 also operates as a gateway device when operating as a setup management device. For example, as a gateway device, the meter 200 acts as a bridge, passing DLMS formatted messages received from a headend server via the transceiver 202 throughout the first type of network via the transceiver 206. In the example of FIG. 2, as a setup management device, the meter 200 publishes DLMS messages to a group address (such as 0xC000) where each messages includes an address corresponding to a target device within the first type of network.

Also, for example, as a non-setup management participant device, the meter 200 subscribes to the group address and monitors for DLMS messages including an address corresponding to the meter 200. In the example of FIG. 2, as a non-setup management participant device, the meter 200 periodically broadcasts a heartbeat message to all setup management devices within proximity of the meter 200. For example, a heartbeat message from a non-setup management participant device notifies setup management devices that the meter 200 is online.

FIG. 3 is a flowchart representative of example operations 300 that may be performed by at least one of software, firmware, or hardware that is at least one of executed, instantiated, or implemented by the meter 200 of FIG. 2 to perform an automated discovery protocol for how the meter 200 is to operate in a first type of network. As illustrated in FIG. 3, the meter 200 auto-discovers a role and performs the role in the first type of network (for example, a BLE mesh network) responsive to connectivity of the meter 200 to the second type of network (for example, a cellular network). The example operations 300 of FIG. 3 begin at block 302, at which the processor core 210 determines communication capabilities of the meter 200.

For example, the processor core 210 determines whether the meter 200 includes at least one of the transceiver 202 or the transceiver 206. In some examples, the processor core 210 determines the type(s) of protocol(s) in which at least one of the transceiver 202 or the transceiver 206 is capable of operating. For example, some transceivers may be designed to operate according to more than one protocol but may be configured for a subset of the protocols when deployed. Also, the processor core 210 determines whether at least one of the transceiver 202 or the transceiver 206 is operating as expected. For example, the processor core 210 determines whether at least one of the transceiver 202 or the transceiver 206 is, for example, coupled to a corresponding one of the antenna 204 or the antenna 208.

Additionally or alternatively, the processor core 210 tests at least one of the transceiver 202 or the transceiver 206 to determine whether the meter 200 can transmit and receive signals via at least one of the transceiver 202 or the transceiver 206. In some examples, the processor core 210 conducts a self-test to determine whether at least one of the transceiver 202 or the transceiver 206 can transmit over a supported bandwidth. Also or alternatively, the processor core 210 tests whether the transceiver 202 can connect to the first type of network and whether the transceiver 206 can connect to the second type of network. If the meter 200 is out of range of an instance of the first type of network (e.g., a BLE mesh network), the processor core 210 determines that the transceiver 202 is not operating as expected. Also, if the meter 200 is out of range of the second type of network (e.g., a cellular network), the processor core 210 determines that the transceiver 206 is not operating as expected.

In the illustrated example of FIG. 3, at block 304, the processor core 210 determines whether the meter 200 can operate in a first type of network. For example, responsive to the processor core 210 at least one of determining that the meter 200 does not include the transceiver 202 or that the transceiver 202 is not operating as expected, the processor core 210 determines that the meter 200 cannot operate in the first type of network. Responsive to the processor core 210 determining that the meter 200 cannot operate in the first type of network (block 304: NO), the at least one of the machine-readable instructions or the operations 300 terminate.

Responsive to the processor core 210 determining that the meter 200 includes the transceiver 202 and that the transceiver 202 is operating as expected, the processor core 210 determines that the meter 200 can operate in the first type of network. Responsive to the processor core 210 determining that the meter 200 can operate in the first type of network (block 304: YES), the at least one of the machine-readable instructions or the operations 300 proceed to block 306. At block 306, the processor core 210 operates the meter 200 as a participant device for the first type of network.

In the illustrated example of FIG. 3, at block 308, the processor core 210 determines whether the meter 200 can operate in a second type of network (such as a cellular network). For example, responsive to the processor core 210 at least one of determining that the meter 200 does not include the transceiver 206 or that the transceiver 206 is not operating as expected, the processor core 210 determines that the meter 200 cannot operate in the second type of network. Responsive to the processor core 210 determining that the meter 200 cannot operate in the second type of network (block 308: NO), the processor core 210 continues to operate the meter 200 as a participant device for the first type of network and the operations 300 terminate.

Responsive to the processor core 210 determining that the meter 200 includes the transceiver 206 and that the transceiver 206 is operating as expected, the processor core 210 determines that the meter 200 can operate in the second type of network. Responsive to the processor core 210 determining that the meter 200 can operate in the second type of network (block 308: YES), the operations 300 proceed to block 310. At block 310, the processor core 210 operates the meter 200 as a setup management device for the first type of network. In the example of FIG. 3, a setup management device is a device that is capable of configuring or provisioning other devices into the first type of network. After configuring the first type of network, the setup management device is to serve as a gateway device between the first type of network and the second type of network.

As illustrated in FIG. 3, the meter 200 can operate as at least one of a setup management device or a participant device. For example, if the meter 200 has no connectivity to the second type of network (e.g., a cellular network), then the processor core 210 starts the meter 200 as a non-setup management participant device (e.g., a BLE mesh device). Alternatively, if the meter 200 has connectivity to the second type of network, the processor core 210 starts the meter 200 as a setup management device and a participant device (e.g., a BLE mesh provisioner and a BLE mesh device). As described above, a setup management device and a participant device each have sub-roles in which the setup management device and the participant device operate.

For example, a setup management device also operates as a gateway device between an instance of the first type of network and the second type of network. In this manner, every meter with connectivity to the second type of network starts up as a setup management participant device (e.g., a provisioner device) and also serves as a gateway device to provide backend connectivity to every meter that connects to (or gets provisioned by) the setup management device. In some examples, each setup management device forms its own instance of the first type of network with its own unique network key and other credentials.

Example sub-roles in which a non-setup management participant device operates include at least one of a relay device, a proxy device, a friend device, or an end device. In examples described herein, a friend device is a participant device that assists at least one participant device utilizing a low power feature (e.g., the low power feature of BLE) by storing at least one message addressed to the at least one participant device. Also, in examples described herein, an end device is a participant device that performs limited roles, primarily focused on at least one of sending or receiving messages rather than relaying messages.

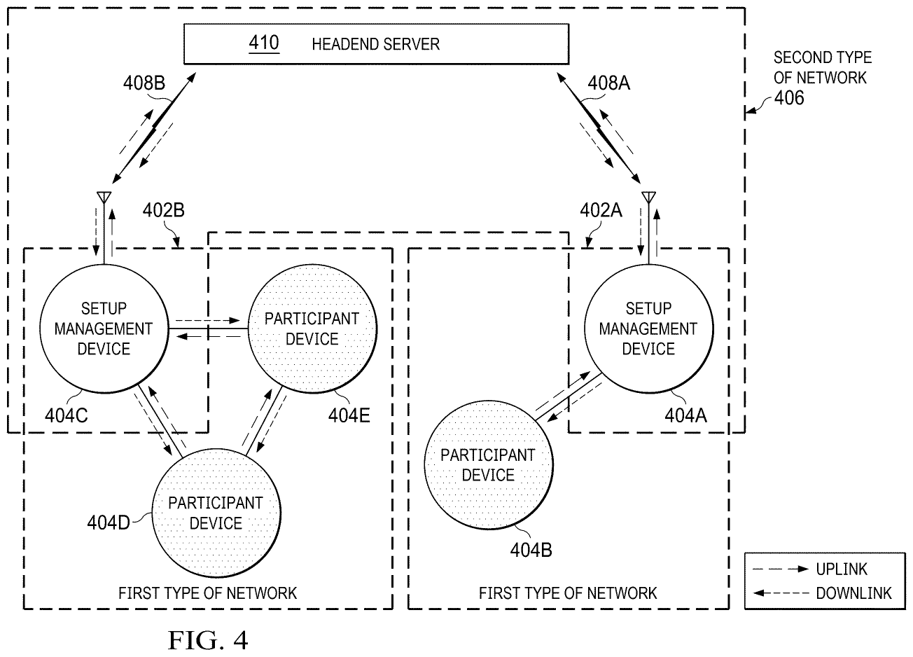

FIG. 4 is a block diagram of two example instances 402A and 402B of a first type of network formed by a fleet of example devices 404A-404E. For example, the fleet of the devices 404A-404E is deployed by a utility entity to a monitoring environment. In some examples, the fleet of the devices 404A-404E includes devices deployed by more than one utility entity. In the example of FIG. 4, the devices 404A-404E are meters. For example, one or more of the devices 404A-404E is/are implemented by a meter similar to the meter 200 of FIG. 2. In the example of FIG. 4, the two instances 402A, 402B of the first type of network are in communication with a second type of example network 406. In the example of FIG. 4, the devices 404A and 404C have connectivity to the second type of network 406. For example, the devices 404A and 404C have cellular connectivity. As such, the devices 404A and 404C can form respective example communication links 408A, 408B with an example headend server 410 via the second type of network 406. In the example of FIG. 4, the headend server 410 is implemented similarly to the headend server 108 of FIG. 1.

In the illustrated example of FIG. 4, the devices 404A and 404C start up as setup management devices and configure or provision the two instances 402A and 402B of the first type of network in an automated manner. In the example of FIG. 4, the device 404A forms the instance 402A of the first type of network. For example, the device 404A transmits a network advertisement message into a physical area around the device 404A. In the example of FIG. 4, the network advertisement message includes network information for the instance 402A of the first type of network. The network information may be identifiable to participant devices deployed by the same utility entity that deployed the device 404A and/or to other devices within the fleet of the devices 404A-404E. Responsive to transmitting a network advertisement message, the device 404A monitors for one or more non-configured messages from one or more participant devices.

In the illustrated example of FIG. 4, the device 404B does not have connectivity to the second type of network 406. For example, the device 404B does not have cellular connectivity. As such, the device 404B starts up as a participant device. In the example of FIG. 4, the device 404B joins a single instance of the first type of network in an automated manner. For example, the device 404B scans the physical area around the device 404B for a valid setup management device. Responsive to a network advertisement message from the device 404A, the device 404B identifies the device 404A as a setup management device capable of configuring or provisioning the device 404B. Responsive to identifying the device 404A as a setup management device capable of configuring the device 404B, the device 404B transmits a non-configured advertisement to the device 404A to join the instance 402A of the first type of network. For example, a non-configured advertisement indicates that a device is not in communication with the first type of network and includes a payload specifying the type of device of the device. In some examples, the payload of a non-configured advertisement specifies that a device is associated with a particular utility entity.

In the illustrated example of FIG. 4, the device 404A scans the physical area around the device 404A for one or more non-configured advertisements. Responsive to receiving a non-configured advertisement from the device 404B, the device 404A authenticates the device 404B. In the example of FIG. 4, the device 404A utilizes a pre-configured static authentication tag or key to perform out-of-band (OOB) authentication of the device 404B. For example, the pre-configured static authentication tag or key is loaded onto the device 404B by a manufacturer of the device 404B. The pre-configured static authentication key is, for example, a configurable pre-shared tag or key that is between one and four bytes.

In some examples, the pre-configured static authentication tag or key is unique for each participant device. In other examples, the pre-configured static authentication tag or key is unique per participant device model. Also or alternatively, the pre-configured static authentication tag or key includes a first portion that is unique per participant device model and a second portion that is unique per participant device. In some examples, the device 404A utilizes certificate-based authentication to authenticate the device 404B. Other authentication techniques can be used in additional or alternative examples. In some examples, the device 404A leverages connectivity to the second type of network 406 (for example, a cellular network) to remotely authenticate the device 404B with the headend server 410 via the communication link 408A. Also or alternatively, the device 404A utilizes locally stored credential(s) to authenticate the device 404B.

In the illustrated example of FIG. 4, responsive to authenticating the device 404B, the device 404A configures or provisions the device 404B. For example, the device 404A configures the device 404B with network credentials to communicate in the instance 402A of the first type of network. In the example of FIG. 4, the device 404A establishes a secure session with the device 404B based on the pre-configured static authentication tag or key and communicates the network credentials to the device 404B via the secure session. Responsive to being configured by the device 404A, the device 404B has joined the instance 402A of the first type of network and established a connection to the device 404A. For example, the connection is represented by the solid line between the device 404B and the device 404A.

In the illustrated example of FIG. 4, responsive to being configured by the device 404A, the device 404B monitors for one or more non-configured messages from one or more out-of-range participant devices. Responsive to such a non-configured message, the device 404B forwards the non-configured message to the device 404A. As such, the device 404A can configure an out-of-range participant device via the device 404B. For example, the device 404B can relay information about a non-configured participant device to the device 404A. Additionally, the device 404B can relay information for configuring the out-of-range participant device to the out-of-range participant device (e.g., information to form a secure session with the device 404A through the device 404B, network credentials for the instance 402A of the first type of network, etc.).

In the illustrated example of FIG. 4, the device 404B also starts broadcasting, or, more generally, sending DLMS formatted messages to the device 404A responsive to being configured. Responsive to a DLMS formatted message, the device 404A forwards the DMLS formatted message to the headend server 410 via the second type of network 406. Also, the device 404A does not forward duplicate messages received from the device 404B to the headend server 410. In the example of FIG. 4, the device 404A also periodically transmits heartbeat messages to the headend server 410 via the second type of network 406.

In the illustrated example of FIG. 4, the connection between the device 404B and the device 404A supports bidirectional communication. Additionally, the communication link 408A between the device 404A and the headend server 410 supports bidirectional communication. As such, the device 404B can send uplink traffic (e.g., DLMS formatted messages) of the device 404B to the device 404A and the device 404A can forward the uplink traffic to the headend server 410. For example, uplink traffic refers to traffic traversing the first type of network and/or the second type of network from a device toward a headend server. Additionally, the device 404A can receive downlink traffic (e.g., control messages) for the device 404B from the headend server 410 and forward the downlink traffic to the device 404B. For example, downlink traffic refers to traffic traversing the first type of network and/or the second type of network from the headend server toward a device. In the example of FIG. 4, the device 404A does not mask addresses of connected participant devices (e.g., the device 404B) communicating uplink traffic to the headend server 410 through the device 404A. Thus, the headend server 410 can keep track of participant devices connected to the device 404A and communicate downlink traffic to the participant devices.

In the illustrated example of FIG. 4, the device 404C forms the instance 402B of the first type of network. For example, the device 404C adds the devices 404D and 404E to the instance 402B of the first type of network similar to how the device 404A adds the device 404B to the instance 402A of the first type of network. Responsive to being configured by the device 404C, the devices 404D and 404E start sending DLMS formatted messages toward the device 404C.

In some examples, if one of the devices 404D or 404E is out-of-range of the device 404C, the other of the devices 404D and 404E relays DLMS formatted messages from the out-of-range participant device to the device 404C. For example, if the device 404E is out-of-range of the device 404C, then the device 404D acts as a relay for the device 404E. In such an example, once the devices 404D and 404E are connected to the instance 402B of the first type of network (e.g., using the same network key and/or other credentials), the device 404D and the device 404E can communicate with one another. As such, the device 404D can relay uplink traffic (e.g., DLMS formatted messages) of the device 404E to the device 404C. Additionally, the device 404D can relay downlink traffic (e.g., control messages) for the device 404E to the device 404E.

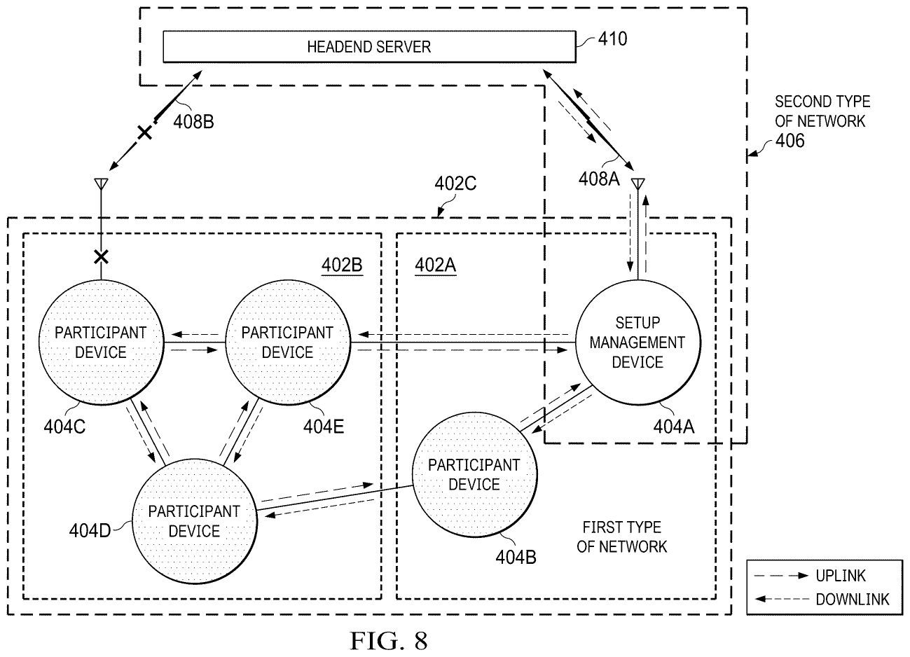

In the illustrated example of FIG. 4, the headend server 410 corresponds to a utility entity managing the two instances 402A and 402B of the first type of network. For example, devices of the two instances 402A and 402B of the first type of network represent a panel or fleet of devices deployed in a monitoring area (such as a residential neighborhood, an apartment building, an industrial facility, etc.) by the utility entity. The two instances 402A and 402B are representative of the panel or fleet of devices. In reality, many more devices than illustrated in FIG. 4 may be included in either of the two instances 402A or 402B of the first type of network. In some examples, one of the devices 404A or 404C may lose connectivity to the second type of network 406. Advantageously, by forming multiple instances of the first type of network, a service person does not need to be deployed to the monitoring environment to service one of the instances of the first type of network. An example of the first type of network self-healing is described in connection with FIG. 8 below.

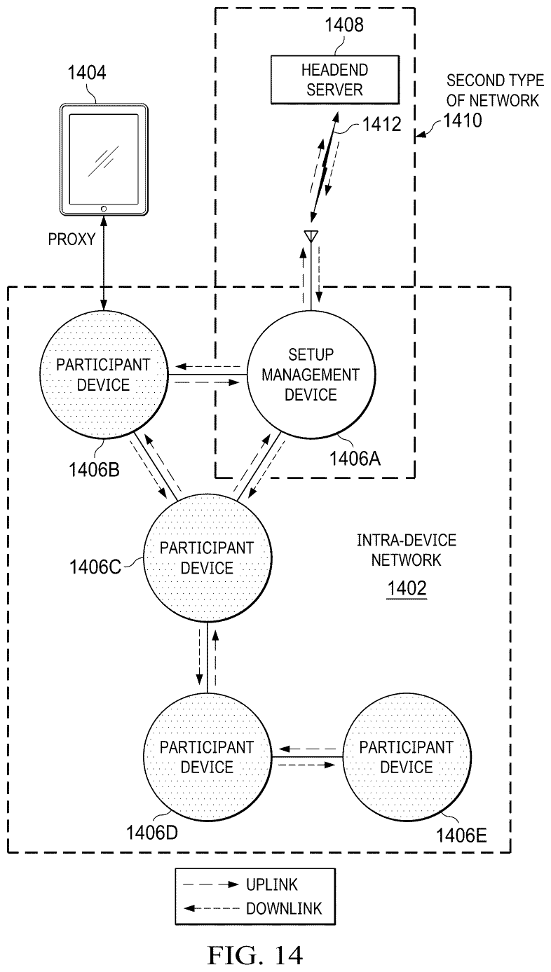

In some examples, a service person associated with the utility entity may be deployed to a monitoring environment to service one or more devices. In such examples, the service person can utilize a service device (such as a phone, not pictured in FIG. 4 but illustrated in FIG. 14) to connect to one or more of the two instances 402A and 402B of the first type of network via a proxy connection between the service device and a proxy device. For example, a service person associated with the utility entity can utilize a service device to connect to an intra-device network including all of the devices of the two instances 402A and 402B of the first type of network. An example of a service device connecting to an intra-device network is described in connection with FIG. 14 below.

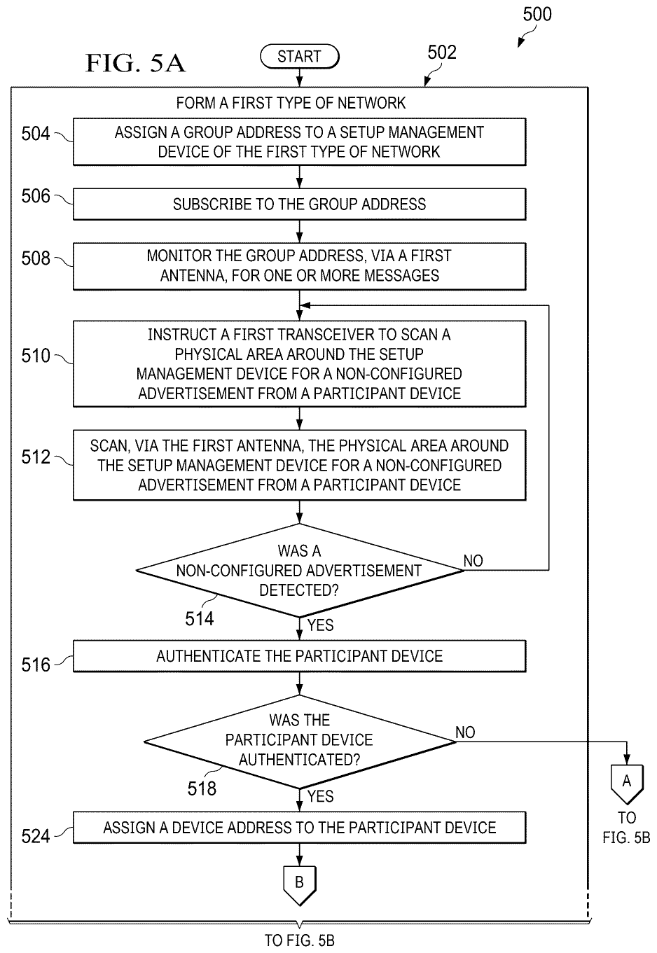

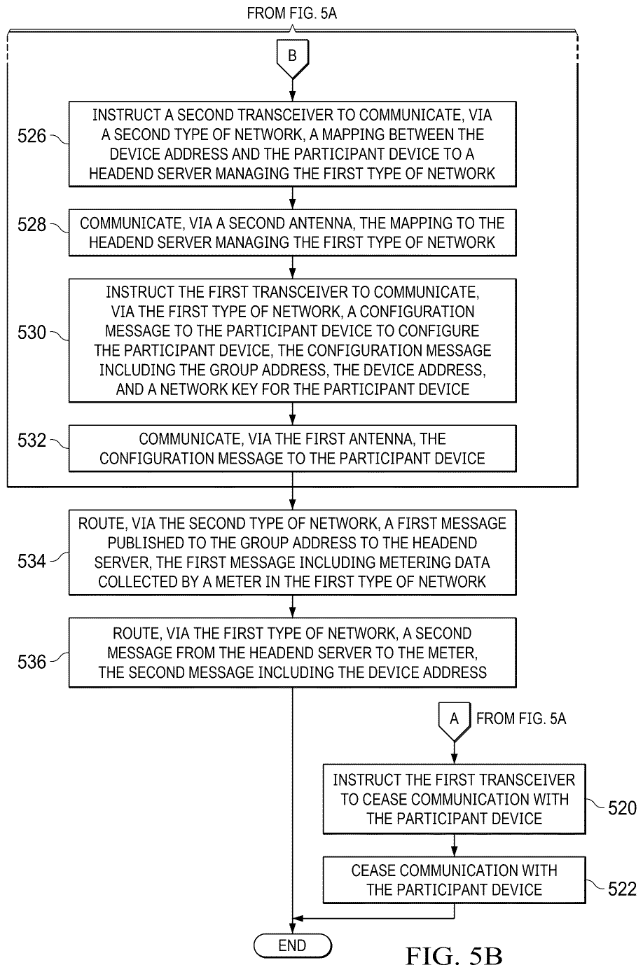

FIGS. 5A and 5B (collectively “FIG. 5”) is a flowchart representative of example operations 500 that may be performed by at least one of software, firmware, or hardware that is at least one of executed, instantiated, or implemented by the meter 200 of FIG. 2 to operate as a setup management device. The example operations 500 of FIG. 5 begin at block 502, at which the meter 200 forms a first type of network. For example, block 502 includes blocks 504-532. At block 504, the processor core 210 assigns a group address to the setup management device (for example, the meter 200) of the first type of network (for example, a BLE mesh network). At block 506, the processor core 210 subscribes to the group address. For example, the processor core 210 instructs the transceiver 202 to monitor, via the first type of network, the group address for one or more messages. At block 508, the transceiver 202 monitors the group address, via the antenna 204, for one or more messages.

In the illustrated example of FIG. 5, at block 510, the processor core 210 instructs the transceiver 202 to scan a physical area around the setup management device for a non-configured advertisement from a participant device. At block 512, the transceiver 202 scans, via the antenna 204, the physical area around the setup management device for a non-configured advertisement from a participant device. At block 514, the processor core 210 determines whether a non-configured advertisement was detected. Responsive to (for example, based on) the processor core 210 determining that a non-configured advertisement was detected (block 514: YES), the operations 500 proceed to block 516. Responsive to (for example, based on) the processor core 210 determining that a non-configured advertisement was not detected (block 514: NO), the operations 500 return to block 510.

In the illustrated example of FIG. 5, at block 516, the processor core 210 authenticates the participant device. At block 518, the processor core 210 determines whether the participant device was authenticated. Responsive to (for example, based on) the processor core 210 determining that the participant device was not authenticated (block 518: NO), the operations 500 proceed to block 520. At block 520, the processor core 210 instructs the transceiver 202 to cease communication with the participant device. At block 522, the transceiver 202 ceases communication with the participant device. Responsive to (for example, based on) the processor core 210 determining that the participant device was authenticated (block 518: YES), the operations 500 proceed to block 524.

In the illustrated example of FIG. 5, at block 524, the processor core 210 assigns a device address to the participant device. As described above, setup management devices have connectivity to a second type of network such as a cellular network. Thus, setup management devices have network addresses such as internet protocol (IP) addresses in the second type of network. In addition to a network address (for example, an internet protocol address), each setup management device has one or more ports that can be assigned to participant devices of the first type of network. Each participant device (including the setup management device) in the first type of network is assigned a device address that includes the network address of the setup management device and a port number of the setup management device that has been assigned to the participant device.

For example, if the setup management device has two ports, then the processor core 210 assigns a default port number (such as port 0) to the setup management device and a first port number (for example, port 1) to the participant device. If a setup management device is the only device in an instance of the first type of network, then the setup management device can utilize its network address as a device address, without a port number. In the example of FIG. 5, to assign a device address to the participant device at block 524, the processor core 210 assigns a network address, port number pair to the participant device. At block 526, the processor core 210 instructs the transceiver 206 to communicate, via the second type of network, a mapping between the device address and the participant device to a headend server managing the first type of network. At block 528, the transceiver 206 communicates, via the antenna 208, the mapping to the headend server managing the first type of network.

In the illustrated example of FIG. 5, the mapping maps a utility ID for the participant device to the network address, port number pair assigned to the participant device. For example, the utility ID is an ID assigned to the participant device by the utility entity. As such, the meter 200 (acting as a gateway device) supports bidirectional communication to and from participant devices of the first type of network. Also, the meter 200 (acting as a gateway device) supports bidirectional communication to and from the headend server managing the first type of network. In this manner, the meter 200 (acting as a gateway device) does not mask addresses of connected participant devices communicating uplink traffic through the meter 200. Thus, the headend server can keep track of participant devices connected to the meter 200 and communicate downlink traffic to the participant devices.

As described above, the headend server managing the first type of network is capable of handling participant devices joining the first type of network via the setup management device. Also, the headend server can route packets to a target participant device via the setup management device. In the example of FIG. 5, at block 530, the processor core 210 instructs the transceiver 202 to communicate, via the first type of network, a configuration message to the participant device to configure the participant device. At block 532, the transceiver 202 communicates, via the antenna 204, the configuration message to the participant device. In the example of FIG. 5, the configuration message includes the group address of the setup management device, the device address assigned to the participant device, and a network key for the participant device.

After being added to the first type of network, the participant device transmits messages including metering data to the group address and the setup management device forwards the messages to the headend server using a metering application protocol like DLMS/COSEM. For example, after forming the first type of network at block 502, the processor core 210 operates the meter 200 as a gateway device between the first type of network and the second type of network. In the example of FIG. 5, at block 534, the processor core 210 routes, via the second type of network, a first message published to the group address to the headend server where the first message includes metering data collected by a meter in the first type of network. To route a message to the headend server, the processor core 210 receives, via the transceiver 202, a message of the first type of network and instructs the transceiver 206 to communicate, via the second type of network, the message to the headend server. Responsive to the instruction from the processor core 210, the transceiver 206 communicates, via the antenna 208, the message to the headend server.

In the illustrated example of FIG. 5, at block 536, the processor core 210 routes, via the first type of network, a second message from the headend server to the meter where the second message includes the device address. For example, the processor core 210 receives, via the transceiver 206, a second message from the headend server that is to manage the first type of network. Also, the processor core 210 determines a device address included in the second message. Responsive to determining that the second message includes the device address assigned to the meter, the processor core 210 instructs the transceiver 202 to communicate, via the first type of network, the second message to the participant device. Responsive to the instruction from the processor core 210, the transceiver 202 communicates, via the antenna 204, the second message to the participant device.

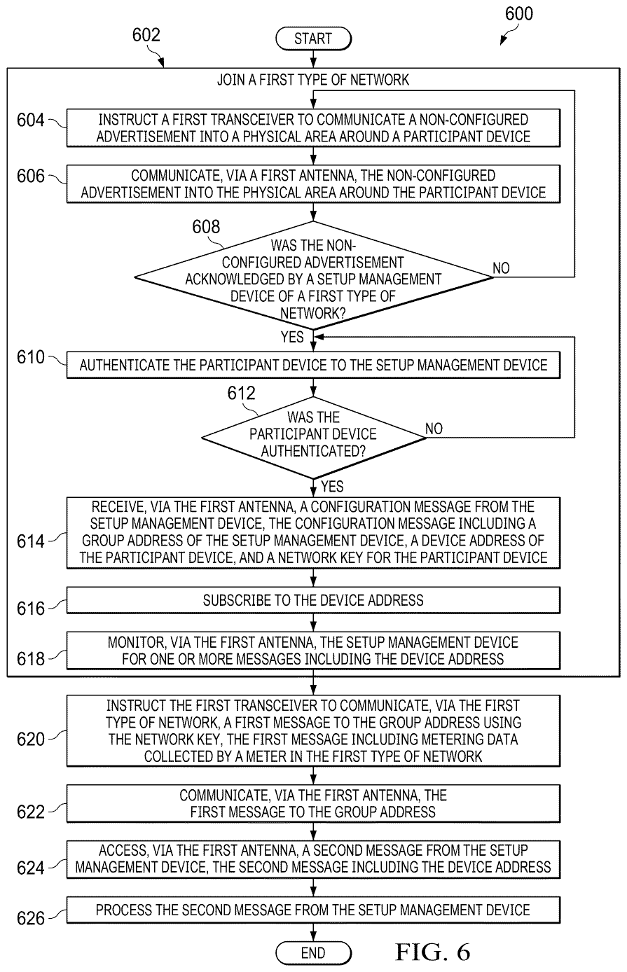

FIG. 6 is a flowchart representative of example operations 600 that may be performed by at least one of software, firmware, or hardware that is at least one of executed, instantiated, or implemented by the meter 200 of FIG. 2 to operate as a participant device. The operations 600 of FIG. 6 begin at block 602, at which the meter 200 joins a first type of network such as a BLE mesh network. For example, block 602 includes blocks 604-618. At block 604, the processor core 210 instructs the transceiver 202 to communicate a non-configured advertisement into a physical area around the participant device. At block 606, the transceiver 202 communicates, via the antenna 204, the non-configured advertisement into the physical area around the participant device.

In the illustrated example of FIG. 6, at block 608, the processor core 210 determines whether the non-configured advertisement was acknowledged by a setup management device of the first type of network. For example, responsive to a non-configured advertisement from a participant device, the setup management device acknowledges receipt of the non-configured advertisement and attempts to authenticate the participant device. Responsive to (for example, based on), the processor core 210 determining that the non-configured advertisement was not acknowledged by the setup management device (block 608: NO), the operations 600 return to block 604. Responsive to (for example, based on), the processor core 210 determining that the non-configured advertisement was acknowledged by the setup management device (block 608: YES), the operations 600 proceed to block 610.

In the illustrated example of FIG. 6, at block 610, the processor core 210 authenticates the participant device to the setup management device. At block 612, the processor core 210 determines whether the participant device was authenticated. Responsive to (for example, based on), the processor core 210 determining that the participant device was not authenticated (block 612: NO), the operations 600 return to block 610. Responsive to (for example, based on), the processor core 210 determining that the participant device was authenticated (block 612: YES), the operations 600 proceed to block 614.

In the illustrated example of FIG. 6, at block 614, the transceiver 202 receives, via the antenna 204, a configuration message from the setup management device. For example, the configuration message includes a group address of the setup management device, a device address of the participant device, and a network key for the participant device. At block 616, the processor core 210 subscribes to the device address. For example, the processor core 210 instructs the transceiver 202 to monitor, via the first type of network, the setup management device for one or more messages including the device address. At block 618, the transceiver 202 monitors, via the antenna 204, the setup management device for one or more messages including the device address.

After joining the first type of network, the processor core 210 instructs the transceiver 202 to send metering data to the setup management device. For example, at block 620, the processor core 210 instructs the transceiver 202 to communicate, via the first type of network, a first message to the group address using the network key. For example, the first message includes metering data collected by a meter in the first type of network. In the example of FIG. 6, the processor core 210 instructs the transceiver 202 to publish the first message to the group address. At block 622, the transceiver 202 communicates, via the antenna 204, the first message to the group address. In the example of FIG. 6, at block 624, the transceiver 202 accesses, via the antenna 204, a second message from the setup management device. For example, the second message includes the device address assigned to the participant device. At block 626, the processor core 210 processes the second message from the setup management device.

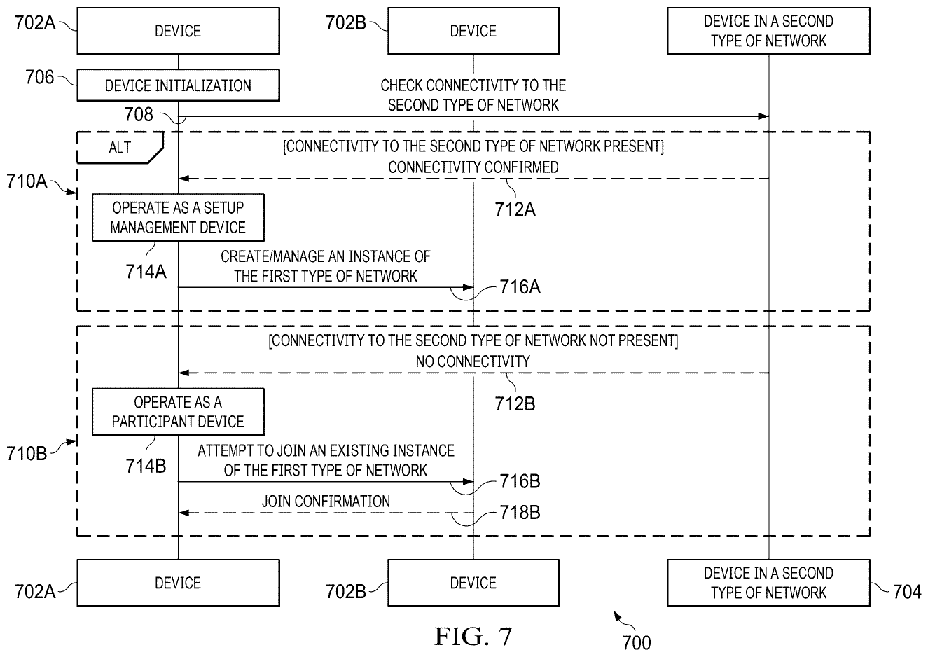

FIG. 7 is a sequence diagram depicting example operations 700 of a first example device 702A depending on connectivity to a second example device 704 in a second type of network. In the example of FIG. 7, the device 702A is a meter. For example, the device 702A is implemented by a meter similar to the meter 200 of FIG. 2. In the example of FIG. 7, the device 702A performs at least operation 706 to initialize the device 702A. Additionally, the device 702A performs at least operation 708 to check connectivity to the second type of network. For example, the device 702A performs operations similar to blocks 302 and 308 of FIG. 3. In some examples, the device 702A attempts to establish a connection with the device 704 in the second type of network. For example, the device 704 facilitates access to the second type of network. The device 704 may be implemented differently depending on what network implements the second type of network. For example, if the second type of network is a cellular network, the device 704 is implemented by a base station. Alternatively, if the second type of network is a Wi-Fi network, the device 704 is implemented by an access point.

In the illustrated example of FIG. 7, depending on the connectivity of the device 702A to the second type of network, the device 702A performs at least operations 710A or at least operations 710B. Responsive to the device 702A confirming connectivity to the second type of network (e.g., during at least operation 712A), the device 702A performs at least operation 714A to operate as a setup management device. To operate as a setup management device, the device 702A performs at least operation 716A to create and manage an instance of the first type of network. For example, the device 702A performs operations similar to the operations 500 of FIG. 5 to operate as a setup management device. As such, a third example device 702B can join the instance of the first type of network created and managed by the device 702A. In the example of FIG. 7, the device 702B is a meter. For example, the device 702B is implemented by a meter similar to the meter 200 of FIG. 2.

In the illustrated example of FIG. 7, responsive to the device 702A confirming that connectivity to the second type of network is not present (e.g., during at least operation 712B), the device 702A performs at least operation 714B to operate as a participant device. To operate as a participant device, the device 702A performs at least operation 716B to attempt to join an existing instance of the first type of network. For example, the device 702A performs operations similar to the operations 600 of FIG. 6 to operate as a participant device. As such, the device 702A can join the instance of the first type of network created and/or managed by the device 702B. After being admitted to the instance of the first type of network, the device 702B sends a join confirmation (e.g., a configuration message) to the device 702A during at least operation 718B.

FIG. 8 is a block diagram depicting how participant devices of the instance 402B of the first type of network of FIG. 4 respond to loss of connectivity between the device 404C (operating as the setup management device for the instance 402B) and the second type of network 406. For example, connectivity between the device 404C and the second type of network 406 (for example, a cellular network) may be disrupted or the device 404C may crash or go offline for another reason. In such examples, the two instances 402A and 402B of the first type of network will self-heal and into a third example instance 402C of the first type of network.

For example, the device 404C (acting as a setup management device) implements a heartbeat service where the device 404C periodically transmits heartbeat messages to the group address of the instance 402B of the first type of network. Each of the devices 404D and 404E subscribes to the heartbeat service to monitor whether the device 404C is still online. For example, the heartbeat messages notify the devices 404D and 404E that the device 404C is operating properly. If the device 404C crashes or loses connectivity to the second type of network 406, the device 404C ceases transmission of heartbeat messages.

Responsive to failing to receive a threshold number of heartbeat messages from the device 404C, the devices 404D and 404E identify that the device 404C has failed (for example, has crashed or lost connectivity to the second type of network 406). Responsive to failure of the device 404C, the devices 404D and 404E restart the discovery process to identify a valid setup management device in an automated manner. For example, the device 404A maintains connectivity to the second type of network 406. As such, the devices 404D and 404E join the instance 402C of the first type of network through the device 404A.

Responsive to failure of the device 404C, the device 404C restarts the automated process to identify a role for the device 404C in the instance 402C of the first type of network. Responsive to the lack of connectivity to the second type of network 406, the device 404C operates as a participant device (for example, a non-setup management participant device). For example, the device 404C is remotely provisioned by the device 404A through one or more of the devices 404B, 404D, or 404E. As such, the two instances 402A and 402B of the first type of network will self-heal into the instance 402C of the first type of network.

As described above, participant devices in the first type of network are assigned a device address including a network address, port number pair. In the example of FIG. 8, the device 404A assigns participant devices joining the instance 402C of the first type of network from the instance 402B of the first type of network a device address utilizing the network address and port numbering of the device 404A. For example, the device 404A assigns the devices 404C-404E a device address utilizing the network address and port numbering of the device 404A. In some examples, because the device 404C previously had connectivity to the second type of network 406, the device 404A assigns the previous network address (for example, IP address) of the device 404C as the device address of the device 404C.

In examples described herein, after failure of a setup management device in a multi-setup management device scenario, setup management devices generally continue to operate as gateway devices between the first type of network and the second type of network provided the setup management devices continue to have connectivity to the second type of network. In some examples, the utility entity managing the first type of network may elect to transition one or more setup management devices to participant devices despite continued connectivity to the second type of network. For example, the utility entity managing the first type of network may elect to transition one or more setup management devices to participant devices for network management reasons (such as load balancing).

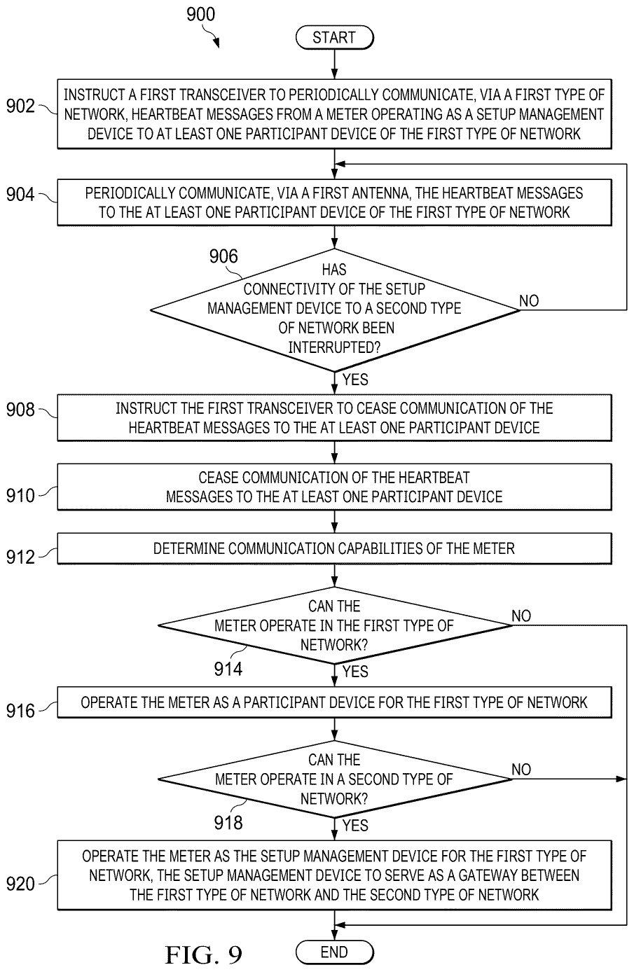

FIG. 9 is a flowchart representative of example operations 900 that may be performed by at least one of software, firmware, or hardware that is at least one of executed, instantiated, or implemented by the meter 200 of FIG. 2 to respond to loss of connectivity with a second type of network when operating as a setup management device. The example operations 900 of FIG. 9 begin at block 902, where the processor core 210 instructs the transceiver 202 to periodically communicate, via a first type of network, heartbeat messages from the meter 200 to at least one participant device of the first type of network. For example, the meter 200 is operating as a setup management device for the first type of network. At block 904, the transceiver 202 periodically communicates, via the antenna 204, the heartbeat messages to the at least one participant device of the first type of network.

In the illustrated example of FIG. 9, at block 906, the processor core 210 determines whether connectivity of the setup management device to the second type of network has been interrupted. For example, the processor core 210 determines whether the transceiver 206 is operating as expected. In some examples, if the meter 200 recently crashed, the processor core 210 determines that connectivity of the setup management device to the second type of network has been interrupted. Additionally or alternatively, if the meter 200 is out-of-range of the second type of network, the processor core 210 determines that connectivity of the setup management device to the second type of network has been interrupted.

Responsive to the processor core 210 determining that connectivity of the setup management device to the second type of network has not been interrupted (block 906: NO), the operations 900 return to block 904. Responsive to the processor core 210 determining that connectivity of the setup management device to the second type of network has been interrupted (block 906: YES), the operations 900 proceed to block 908. At block 908, the processor core 210 instructs the transceiver 202 to cease communication of the heartbeat messages to the at least one participant device. At block 910, the transceiver 202 ceases communication of the heartbeat messages to the at least one participant device.

In the illustrated example of FIG. 9, at block 912, the processor core 210 determines communication capabilities of the meter 200. For example, the processor core 210 determines whether at least one of the transceiver 202 or the transceiver 206 is operating as expected. For example, the processor core 210 determines whether at least one of the transceiver 202 or the transceiver 206 is, for example, coupled to a corresponding one of the antenna 204 or the antenna 208. Additionally or alternatively, the processor core 210 tests at least one of the transceiver 202 or the transceiver 206 to determine whether the meter 200 can transmit and receive signals via at least one of the transceiver 202 or the transceiver 206.

In some examples, the processor core 210 conducts a self-test to determine whether at least one of the transceiver 202 or the transceiver 206 can transmit over a supported bandwidth. Also or alternatively, the processor core 210 tests whether the transceiver 202 can connect to the first type of network and whether the transceiver 206 can connect to the second type of network. If the meter 200 is out of range of an instance of the first type of network (e.g., a BLE mesh network), the processor core 210 determines that the transceiver 202 is not operating as expected. Also, if the meter 200 is out of range of the second type of network (e.g., a cellular network), the processor core 210 determines that the transceiver 206 is not operating as expected.

In the illustrated example of FIG. 9, at block 914, the processor core 210 determines whether the meter 200 can operate in the first type of network. For example, responsive to the processor core 210 determining that the transceiver 202 is not operating as expected, the processor core 210 determines that the meter 200 cannot operate in the first type of network. Responsive to the processor core 210 determining that the meter 200 cannot operate in the first type of network (block 914: NO), the operations 900 terminate. Responsive to the processor core 210 determining that the transceiver 202 is operating as expected, the processor core 210 determines that the meter 200 can operate in the first type of network. Responsive to the processor core 210 determining that the meter 200 can operate in the first type of network (block 914: YES), the operations 900 proceed to block 916.

In the illustrated example of FIG. 9, at block 916, the processor core 210 operates the meter 200 as a participant device for the first type of network. In the example of FIG. 9, at block 918, the processor core 210 determines whether the meter 200 can operate in the second type of network. For example, the processor core 210 checks if connectivity between the meter 200 and the second type of network has returned. Responsive to the processor core 210 determining that the transceiver 206 is not operating as expected, the processor core 210 determines that the meter 200 cannot operate in the second type of network. Responsive to the processor core 210 determining that the meter 200 cannot operate in the second type of network (block 918: NO), the operations 900 terminate and the meter 200 rejoins the first type of network as a non-setup management participant device.

For example, the processor core 210 instructs the transceiver 202 to communicate a non-configured advertisement into a physical area around the meter 200 to join the first type of network as a participant device. Responsive to the processor core 210 determining that the transceiver 206 is operating as expected, the processor core 210 determines that the meter 200 can operate in the second type of network. Responsive to the processor core 210 determining that the meter 200 can operate in the second type of network (block 918: YES), the operations 900 proceed to block 920. At block 920, the processor core 210 operates the meter 200 as a setup management device for the first type of network.

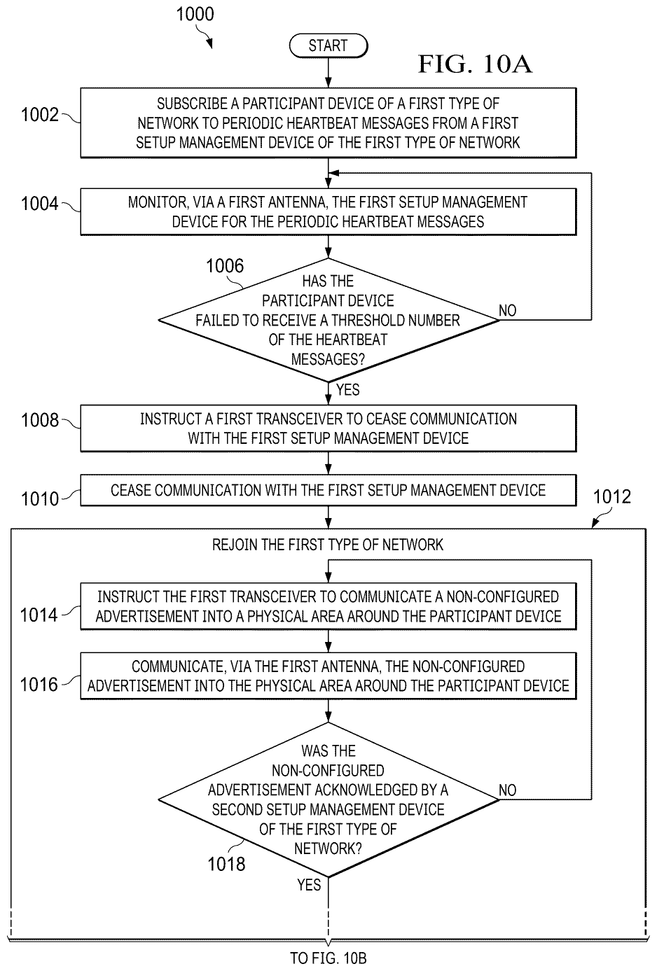

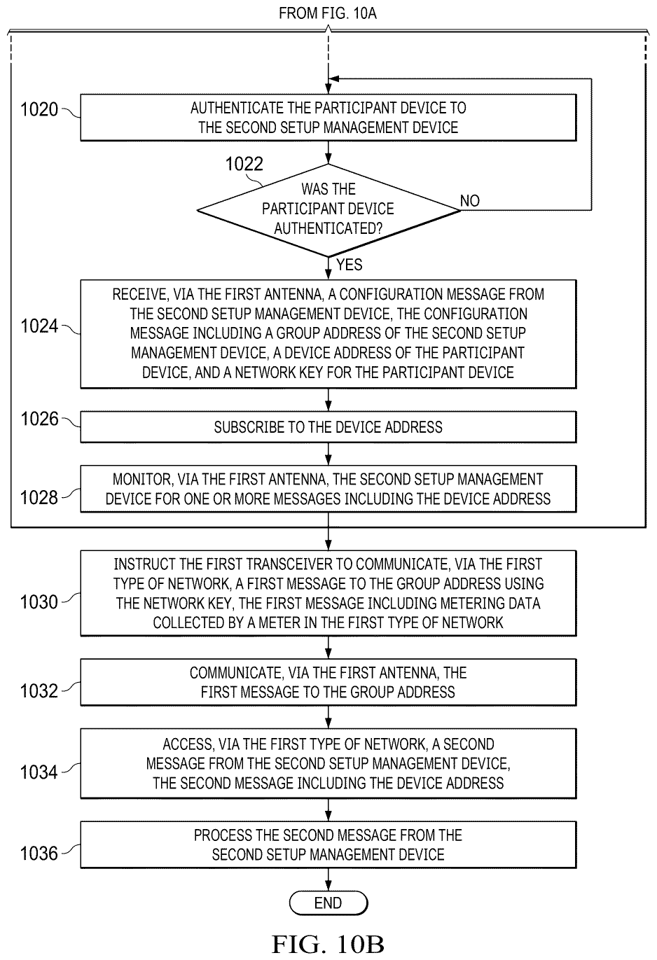

FIGS. 10A and 10B (collectively “FIG. 10”) is a flowchart representative of example operations 1000 that may be performed by at least one of software, firmware, or hardware that is at least one of executed, instantiated, or implemented by the meter 200 of FIG. 2 to rejoin a first type of network when operating as a participant device responsive to a first setup management device losing connectivity with a second type of network. The example operations 1000 of FIG. 10 begin at block 1002, at which the processor core 210 subscribes the participant device of the first type of network to periodic heartbeat messages from the first setup management device of the first type of network. For example, the processor core 210 instructs the transceiver 202 to monitor, via the first type of network, the first setup management device for periodic heartbeat messages. At block 1004, the transceiver 202 monitors, via the antenna 204, the first setup management device for the periodic heartbeat messages.

In the illustrated example of FIG. 10, at block 1006, the processor core 210 determines whether the participant device has failed to receive a threshold number of heartbeat messages. Responsive to the processor core 210 determining that the participant device has not failed to receive the threshold number of heartbeat message (block 1006: NO), the operations 1000 return to block 1004. Responsive to the processor core 210 determining that the participant device has failed to receive the threshold number of heartbeat message (block 1006: YES), the operations 1000 proceed to block 1008.

In the illustrated example of FIG. 10, at block 1008, the processor core 210 instructs the transceiver 202 to cease communication with the first setup management device. At block 1010, the transceiver 202 ceases communication with the first setup management device. In the example of FIG. 10, at block 1012, the processor core 210 rejoins the first type of network. For example, block 1012 includes blocks 1014-1028. At block 1014, the processor core 210 instructs the transceiver 202 to communicate a non-configured advertisement into a physical area around the participant device. At block 1016, the transceiver 202 communicates, via the antenna 204, the non-configured advertisement into the physical area around the participant device. At block 1018, the processor core 210 determines whether the non-configured advertisement was acknowledged by a second setup management device of the first type of network.

Responsive to (for example, based on), the processor core 210 determining that the non-configured advertisement was not acknowledged by the second setup management device (block 1018: NO), the operations 1000 return to block 1014. Responsive to (for example, based on), the processor core 210 determining that the non-configured advertisement was acknowledged by the second setup management device (block 1018: YES), the operations 1000 proceed to block 1020. At block 1020, the processor core 210 authenticates the participant device to the second setup management device. At block 1022, the processor core 210 determines whether the participant device was authenticated.

Responsive to (for example, based on), the processor core 210 determining that the participant device was not authenticated (block 1022: NO), the operations 1000 return to block 1020. Responsive to (for example, based on), the processor core 210 determining that the participant device was authenticated (block 1022: YES), the operations 1000 proceed to block 1024. At block 1024, the transceiver 202 receives, via the antenna 204, a configuration message from the second setup management device. For example, the configuration message includes a group address of the second setup management device, a device address of the participant device, and a network key for the participant device. At block 1026, the processor core 210 subscribes to the device address. For example, the processor core 210 instructs the transceiver 202 to monitor, via the first type of network, the second setup management device for one or more messages including the device address. At block 1028, the transceiver 202 monitors, via the antenna 204, the second setup management device for one or more messages including the device address.

After joining the first type of network, the processor core 210 instructs the transceiver 202 to send metering data to the second setup management device. For example, at block 1030, the processor core 210 instructs the transceiver 202 to communicate, via the first type of network, a first message to the group address using the network key. For example, the first message includes metering data collected by a meter in the first type of network. In the example of FIG. 10, the processor core 210 instructs the transceiver 202 to publish the first message to the group address. At block 1032, the transceiver 202 communicates, via the antenna 204, the first message to the group address. In the example of FIG. 10, at block 1034, the transceiver 202 accesses, via the antenna 204, a second message from the second setup management device. For example, the second message includes the device address assigned to the participant device. At block 1036, the processor core 210 processes the second message from the second setup management device.

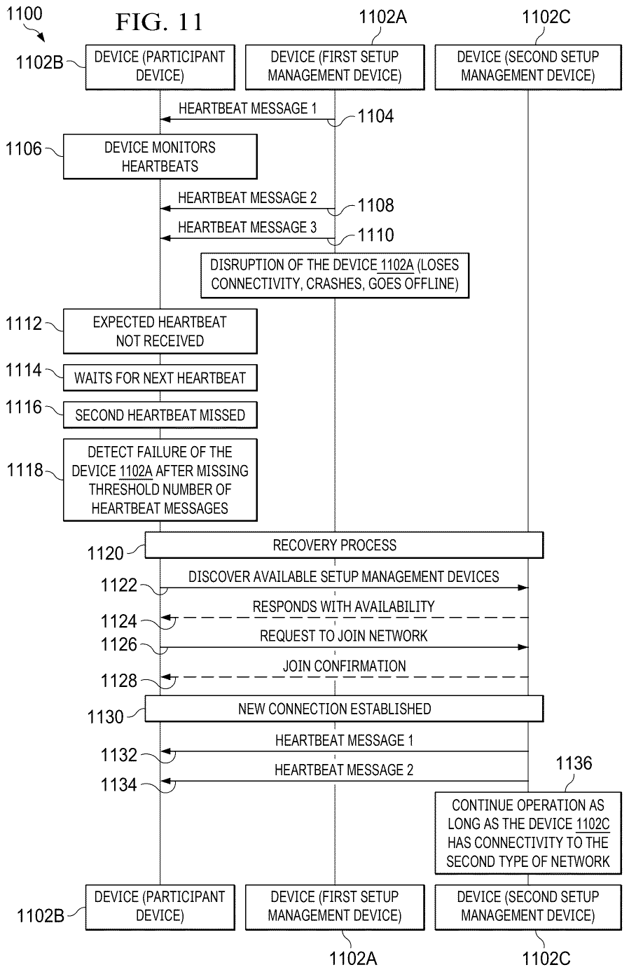

FIG. 11 is a sequence diagram depicting example operations 1100 to respond to a first example device 1102A operating as a setup management device losing connectivity with a second type of network. In the example of FIG. 11, the device 1102A and a second example device 1102B are meters. For example, one or more of the devices 1102A. 1102B is/are implemented by a meter similar to the meter 200 of FIG. 2. In the example of FIG. 11, the device 1102A is operating as a setup management device and the device 1102B is operating as a participant device. For example, the device 1102A performs at least operation 1104 to send a first heartbeat message to the device 1102B. Responsive to receiving the first heartbeat message, the device 1102B performs at least operation 1106 to monitor heartbeat messages from the device 1102A.

In the illustrated example of FIG. 11, the device 1102A performs at least operation 1108 to send a second heartbeat message to the device 1102B. Additionally, the device 1102A performs at least operation 1110 to send a third heartbeat message to the device 1102B. After performing at least operation 1110, the device 1102A is disrupted. For example, the device 1102A loses connectivity to the second type of network. In some examples, the device 1102A crashes. Additionally or alternatively, the device 1102A goes offline (e.g., responsive to a service message from a service device). After the device 1102A is disrupted, the device 1102A does not send further heartbeat messages.

In the illustrated example of FIG. 11, the device 1102B performs at least operation 1112 to detect that an expected heartbeat message was not received. Additionally, the device 1102B performs at least operation 1114 to wait for a next heartbeat message. In the example of FIG. 11, the device 1102B performs at least operation 1116 to detect that the next heartbeat message was not received. After failing to receive a threshold number of heartbeat messages, the device 1102B performs at least operation 1118 to detect failure of the device 1102A. Responsive to detecting failure of the device 1102A, the device 1102B performs an example recovery process 1120. During the recover process 1120, the device 1102B performs at least operation 1122 to discover available setup management devices. For example, the device 1102B transmits a non-configured advertisement into the physical area around the device 1102B.

Responsive to the non-configured advertisement, a third example device 1102C performs at least operation 1124 to respond with availability to the device 1102B. For example, the device 1102C acknowledges the non-configured advertisement. In the example of FIG. 11, the device 1102C is a meter. For example, the device 1102C is implemented by a meter similar to the meter 200 of FIG. 2. In the example of FIG. 11, the device 1102B performs at least operation 1126 to request to join an instance of the first type of network. For example, the device 1102B authenticates itself to the device 1102C. After the device 1102B is authenticated by the device 1102C, the device 1102C sends a join confirmation (e.g., a configuration message) to the device 1102B during at least operation 1128. As such, the device 1102B performs at least operation 1130 to establish a new connection to the first type of network.

After establishing the new connection, the device 1102B subscribes to a heartbeat service of the device 1102C. For example, the device 1102C performs at least operation 1132 to send a first heartbeat message to the device 1102B. Additionally, the device 1102C performs at least operation 1134 to send a second heartbeat message to the device 1102B. In the example of FIG. 11, the device 1102C performs at least operation 1136 to continue operation. For example, the device 1102C continues operating as a gateway for the device 1102B and continues to provide heartbeat messages to the device 1102B as long as the device 1102C has connectivity to the second type of network.

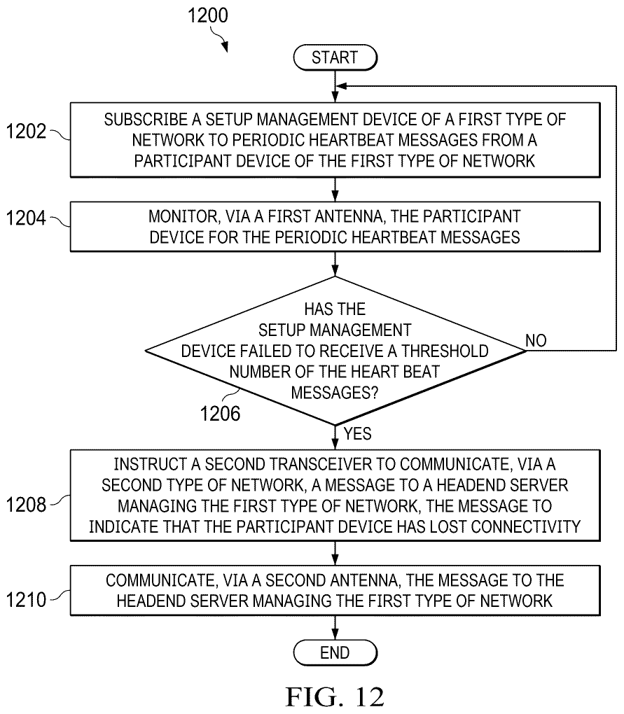

FIG. 12 is a flowchart representative of example operations 1200 that may be performed by at least one of software, firmware, or hardware that is at least one of executed, instantiated, or implemented by the meter 200 of FIG. 2 to respond to loss of connectivity with a participant device when operating as a setup management device. The example operations 1200 of FIG. 12 begin at block 1202, at which the processor core 210 subscribes the setup management device of a first type of network to periodic heartbeat messages from a participant device of the first type of network. For example, the participant device periodically communicates, via the first type of network, heartbeat messages to the group address of the setup management device.

As such, the processor core 210 instructs the transceiver 202 to monitor, via the first type of network, the participant device for the periodic heartbeat messages. At block 1204, the transceiver 202 monitors, via the antenna 204, the participant device for the periodic heartbeat messages. Thus, the processor core 210 will receive, via the transceiver 202, periodic heartbeat messages from the participant device. At block 1206, the processor core 210 determines whether the setup management device has failed to receive a threshold number of heartbeat messages. Responsive to (for example, based on), the processor core 210 determining that the setup management device has not failed to receive the threshold number of heartbeat message (block 1206: NO), the operations 1200 return to block 1202.

Responsive to (for example, based on), the processor core 210 determining that the setup management device has failed to receive the threshold number of heartbeat message (block 1206: YES), the operations 1200 proceed to block 1208. At block 1208, the processor core 210 instructs the transceiver 206 to communicate, via a second type of network, a message to a headend server managing the first type of network. For example, the message indicates that the participant device has lost connectivity. At block 1210, the transceiver 206 communicates, via the antenna 208, the message to the headend server managing the first type of network. As such, the setup management notifies the headend server when a meter that is not serving as a gateway device loses connectivity (for example, due to a crash or other reasons). In some examples, the headend server can implement additional or alternative application-based keep-alive techniques to track meters that are still in communication with the headend server.

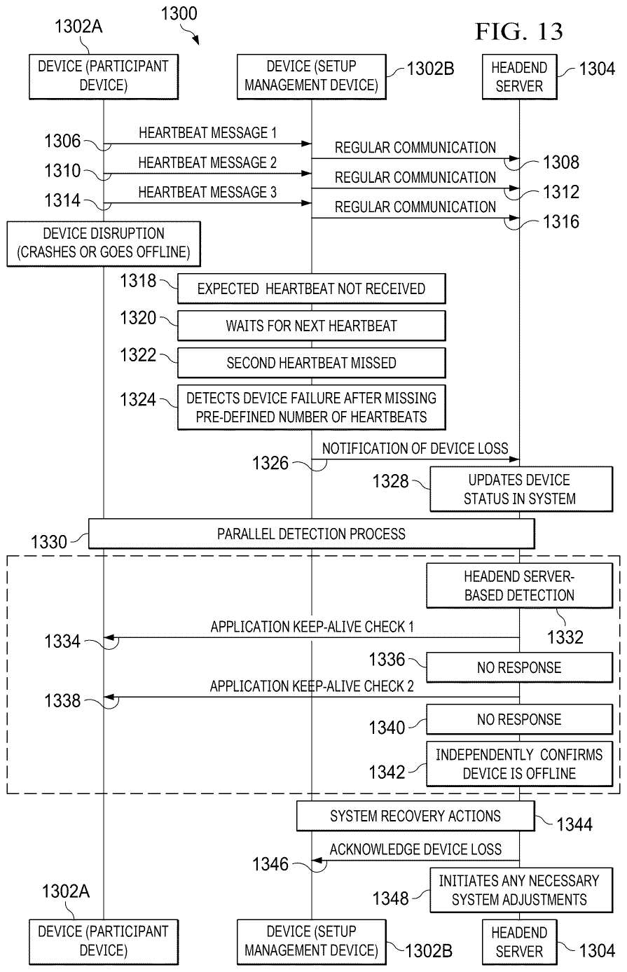

FIG. 13 is a sequence diagram depicting example operations 1300 to respond to a first example device 1302A operating as a participant device losing connectivity with a second example device 1302B operating as a setup management device. In the example of FIG. 13, the device 1302A and the device 1302B are meters. For example, one or more of the devices 1302A, 1302B is/are implemented by a meter similar to the meter 200 of FIG. 2. In the example of FIG. 13, the device 1302A is operating as a participant device and the device 1302B is operating as a setup management device in communication with an example headend server 1304. For example, the headend server 1304 is implemented similarly to the headend server 108 of FIG. 1. During operation, the device 1302A performs at least operation 1306 to send a first heartbeat message to the device 1302B. Responsive to receiving the first heartbeat message, the device 1302B performs at least operation 1308 to notify the headend server 1304 that regular communication is present with the device 1302A.

In the illustrated example of FIG. 13, the device 1302A performs at least operation 1310 to send a second heartbeat message to the device 1302B. Responsive to receiving the second heartbeat message, the device 1302B performs at least operation 1312 to notify the headend server 1304 that regular communication is present with the device 1302A. Additionally, the device 1302A performs at least operation 1314 to send a third heartbeat message to the device 1302B. Responsive to receiving the third heartbeat message, the device 1302B performs at least operation 1316 to notify the headend server 1304 that regular communication is present with the device 1302A. After performing at least operation 1316, the device 1302A is disrupted. For example, the device 1302A loses connectivity to the first type of network. In some examples, the device 1302A crashes. Additionally or alternatively, the device 1302A goes offline (e.g., responsive to a service message from a service device). After the device 1302A is disrupted, the device 1302A does not send further heartbeat messages.

In the illustrated example of FIG. 13, the device 1302B performs at least operation 1318 to detect that an expected heartbeat message was not received. Additionally, the device 1302B performs at least operation 1320 to wait for a next heartbeat message. In the example of FIG. 13, the device 1302B performs at least operation 1322 to detect that the next heartbeat message was not received. After failing to receive a threshold number of heartbeat messages, the device 1302B performs at least operation 1324 to detect failure of the device 1302A. Responsive to detecting failure of the device 1302A, the device 1302B performs at least operation 1326 to notify the headend server 1304 that the device 1302A has failed. Responsive to the notification, the headend server 1304 performs at least operation 1328 to update the status of the device 1302A in an internal system of the utility entity managing the devices 1302A and 1302B.

In some examples, the headend server 1304 performs an example parallel detection process 1330. During the parallel detection process 1330, the headend server 1304 performs example headend server-based detection 1332. For example, the headend server 1304 performs at least operations 1334-1342. In the example of FIG. 13, the headend server 1304 performs at least operation 1334 to send a keep-alive check to the device 1302A. Additionally, the headend server 1304 performs at least operation 1336 to detect that a response was not received from the device 1302A. In the example of FIG. 13, the headend server 1304 performs at least operation 1338 to send a second keep-alive check to the device 1302A. Additionally, the headend server 1304 performs at least operation 1340 to detect that a response was not received from the device 1302A.

After failing to receive a threshold number of responses to the keep-alive checks, the headend server 1304 performs at least operation 1342 to detect failure of the device 1302A. Responsive to detecting failure of the device 1302A (e.g., via the device 1302B and/or via the parallel detection process 1330), the headend server 1304 performs one or more example system recovery actions 1344. For example, the headend server 1304 performs at least operation 1346 to notify the device 1302B that the headend server 1304 has acknowledged loss of the device 1302A. Additionally, the headend server 1304 performs at least operation 1348 to initiate any adjustments to a fleet of devices deployed in a monitoring environment. Example adjustments include scheduling service for the device 1302A.

FIG. 14 is a block diagram of an example intra-device network 1402 capable of responding to a service message from an example service device 1404. In the example of FIG. 14, the intra-device network 1402 includes example devices 1406A-1406E. Additionally, the fleet of the devices 1406A-1406E are managed by an example headend server 1408. In the example of FIG. 14, the devices 1406A-1406E are meters. For example, one or more of the devices 1406A-1406E is/are implemented by a meter similar to the meter 200 of FIG. 2. Also, for example, the headend server 1408is implemented similarly to the headend server 108 of FIG. 1. In some examples, the headend server 1408 schedules maintenance of at least one of the devices 1406A-1406E. For example, a service person may be dispatched to perform diagnostics on a target meter, or, more generally, a target device. As described above, multiple instances of a first type of network (such as a BLE mesh network) may have been formed between the devices 1406A-1406E due to the presence of multiple devices with connectivity to a second type of example network 1410 (such as a cellular network). In such cases, the service person may not know which device to connect to in order to access the target device.

Advantageously, all the devices 1406A-1406E of the fleet of devices form the intra-device network 1402 in addition to individual instances of the first type of network to which the devices 1406A-1406E are connected. In this manner, each device is part of a first network (e.g., a first BLE mesh network) to identify a setup management device and report data (e.g., metering data) and a second, intra-device network (e.g., a second BLE mesh network) where all devices join a common network. In some examples, formation of the intra-device network 1402 (also referred to as an intra-meter network) is controlled by the headend server 1408 managing the fleet of the devices 1406A-1406E. For example, the headend server 1408 assigns one device with connectivity to the second type of network 1410 per region to be a setup management device.

Also or alternatively, each device with connectivity to the second type of network 1410 queries the headend server 1408 to determine whether the device is to operate as a setup management device or a participant device of the intra-device network 1402. Based on the locations of the devices with connectivity to the second type of network 1410, the headend server 1408 assigns one device to be the setup management device of the intra-device network 1402. In some examples, formation of the intra-device network 1402 can be static and pre-configured. For example, all devices are manufactured with a pre-configured or pre-defined network key and a unique network ID for the intra-device network 1402. As such, once a device is deployed, the device can join the intra-device network 1402 without needing to communicate with a setup management device.

In the illustrated example of FIG. 14, the device 1406A operates as a setup management device for the intra-device network 1402. As such. The device 1406A establishes an example communication link 1412 with the headend server 1408. Additionally, the devices 1406B-1406E operate as participant devices of the intra-device network 1402. To operate in the intra-device network 1402, each of the devices 1406A-1406E periodically advertise the network key and network ID of the intra-device network 1402 and relay messages between participant devices of the intra-device network 1402. A service person utilizing the service device 1404 (for example, a handheld device such as a phone) can form a proxy connection with, for example, the device 1406B and monitor the device 1406B for such an advertisement. For example, the devices 1406A-1406E can utilize always-on advertisements to advertise the intra-device network 1402. Also or alternatively, the service device 1404 can send a solicitation PDU to one of the devices 1406A-1406E to identify the intra-device network 1402.

Using the information included in an advertisement, the service person can identify all the devices 1406A-1406E of the intra-device network 1402. By doing so, the service person can properly identify the target device to be serviced. Example service includes replacing or restarting a device in the intra-device network 1402. A service person can take any non-setup management device of the intra-device network 1402 offline without affecting other participant devices of the intra-device network 1402. To take a target device offline, the service person utilizes the service device 1404 to send a control signal to the target device via the proxy connection. Responsive to the control signal, the target device disables and goes offline. Additionally or alternatively, the service person can manually disable the target device to take the target device offline. When a service person takes a setup management device of an instance of the first type of network (such as the first type of network 106 of FIG. 1) offline, other participant devices of the instance of the first type of network restart the discovery process to identify a valid setup management device in an automated manner. As such, examples described herein provide flexible handling of remote device management and in-person service.

In some examples, the service device 1404 can be utilized as a portable setup management device or portable gateway device to form a first type of network by configuring one or more proxy devices within radio range of the service device 1404. The service device 1404 can configure any devices outside of the radio range of the service device 1404 via other devices already in the first type of network. For example, provided that the non-configured devices are within radio range of the configured devices, the configured devices can relay non-configured advertisements from the non-configured devices to the service device 1404 and can relay configuration messages from the service device 1404 to the non-configured devices. After a device is configured, the device starts broadcasting DLMS formatted messages, which are relayed, until the DLMS formatted messages reach a setup management device (such as the device 1406A) that collects and forwards the DLMS formatted messages as described above. As such, the service device 1404 only needs to be within radio range of one device to access the entirety of the intra-device network 1402, mitigating the difficulties presented by not being able to access out-of-range or physically obstructed devices.

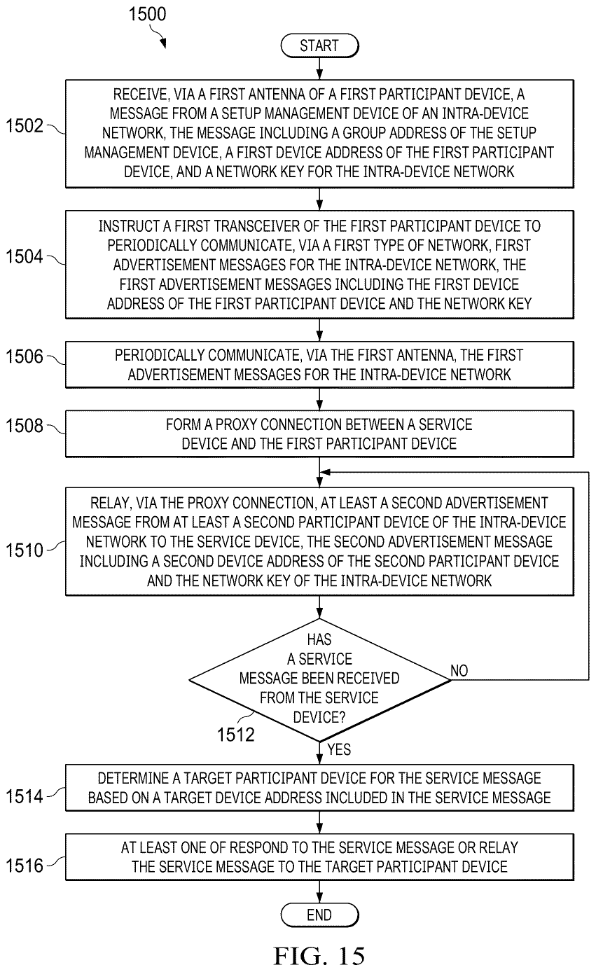

FIG. 15 is a flowchart representative of example operations 1500 that may be performed by at least one of software, firmware, or hardware that is at least one of executed, instantiated, or implemented by the meter 200 of FIG. 2 to operate in an intra-device network. The example operations 1500 of FIG. 15 begin at block 1502, at which the transceiver 202 receives, via the antenna 204 of a participant device, a message from a setup management device of the intra-device network. For example, the message includes a group address of the setup management device, a first device address of the first participant device, and a network key for the intra-device network.

In the illustrated example of FIG. 15, at block 1504, the processor core 210 instructs the transceiver 202 to periodically communicate, via a first type of network, first advertisement messages for the intra-device network. For example, the first type of network is a BLE mesh network. In the example of FIG. 15, the first advertisement messages include the first device address of the first participant device and the network key for the intra-device network. At block 1506, the transceiver 202 periodically communicate, via the antenna 204, the first advertisement messages for the intra-device network. In the example of FIG. 15, the processor core 210 forms a proxy connection between a service device and the first participant device at block 1508.

In the illustrated example of FIG. 15, at block 1510, the processor core 210 the processor core 210 relays, via the proxy connection, at least a second advertisement message from at least a second participant device of the intra-device network to the service device. For example, the processor core 210 receives, via the transceiver 202, the second advertisement message from the second participant device. Responsive to receiving the second advertisement message, the processor core 210 instructs the transceiver 202 to communicate, via the proxy connection, the second advertisement message to the service device. Responsive to the instruction from the processor core 210, the transceiver 202 communicates, via the antenna 204, the second advertisement message to the service device.

In the illustrated example of FIG. 14, at block 1512, the processor core 210 determines whether a service message has been received from the service device. Responsive to (for example, based on), the processor core 210 determining that the service message has not been received from the service device (block 1512: NO), the operations 1500 return to block 1510. Responsive to (for example, based on), the processor core 210 determining that the service message has been received from the service device (block 1512: YES), the operations 1500 proceed to block 1514. In the example of FIG. 15, at block 1514, the processor core 210 determines a target participant device for the service message based on a target device address included in the service message. At block 1516, the processor core 210 at least one of responds to the service message or relays the service message to the target participant device.

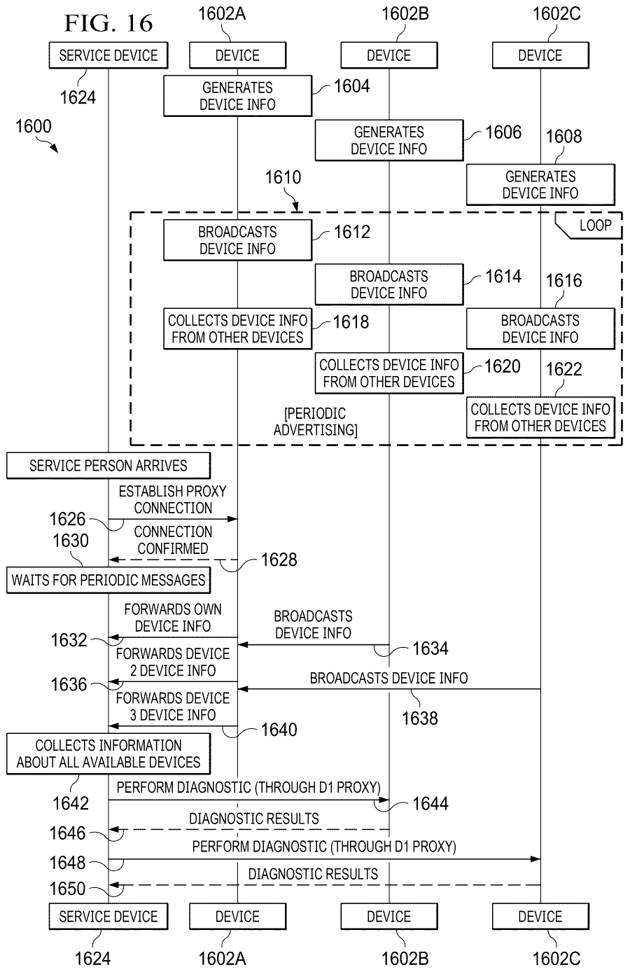

FIG. 16 is a sequence diagram depicting example operations 1600 of example devices 1602A-1602C in an intra-device network. In the example of FIG. 16, the devices 1602A-1602C are meters. For example, one or more of the devices 1602A-1602C is/are implemented by a meter similar to the meter 200 of FIG. 2. In the example of FIG. 16, the devices 1602A-1602C are operating in the intra-device network. For example, the device 1602A performs at least operation 1604 to generate a first advertisement message. For example, the first advertisement message includes a device address of the device 1602A and a network key for the intra-device network. Additionally, the device 1602B performs at least operation 1606 to generate a second advertisement message and the device 1602C performs at least operation 1608 to generate a third advertisement message.

In the illustrated example of FIG. 16, after each of the devices 1602A-1602C generates an advertisement message, the devices 1602A-1602C enter an example periodic advertising loop 1610. For example, in the periodic advertising loop 1610, the device 1602A performs at least operation 1612 to broadcast the first advertisement message into a physical area around the device 1602A. Additionally, in the periodic advertising loop 1610, the device 1602B performs at least operation 1614 to broadcast the second advertisement message into a physical area around the device 1602B. In the periodic advertising loop 1610, the device 1602C also performs at least operation 1616 to broadcast the third advertisement message into a physical area around the device 1602C. In the periodic advertising loop 1610, the device 1602A also performs at least operation 1618 to collect device information from other devices 1602B, 1602C. Additionally, in the periodic advertising loop 1610, the device 1602B performs at least operation 1620 to collect device information from other devices 1602A, 1602C. In the periodic advertising loop 1610, the device 1602C performs at least operation 1622 to collect device information from other devices 1602A, 1602B.

In the illustrated example of FIG. 16, the devices 1602A-1602C exit the periodic advertising loop 1610 when a service person arrives and utilizes an example service device 1624 to form a proxy connection with one of the devices 1602A-1602C. For example, the service device 1624 is implemented similarly to the service device 114 of FIG. 1. In the example of FIG. 16, the service person detects the first advertisement message with the service device 1624, and, after detecting the first advertisement message, the service device 1624 performs at least operation 1626 to establish a proxy connection with the device 1602A. Additionally, the device 1602A performs at least operation 1628 to confirm to the service device 1624 that the proxy connection has been established. After the proxy connection is established, the service device 1624 performs at least operation 1630 to wait for periodic messages from the devices 1602A-1602C. For example, the device 1602A performs at least operation 1632 to send the first advertisement message to the service device 1624.

Additionally, the device 1602B performs at least operation 1632 to broadcast the second advertisement message. In the example of FIG. 16, the device 1602A performs at least operation 1636 to forward the second advertisement message to the service device 1624. Additionally, the device 1602C performs at least operation 1638 to broadcast the third advertisement message. In the example of FIG. 16, the device 1602A performs at least operation 1640 to forward the third advertisement message to the service device 1624. Based on the first, second, and third advertisement messages, the service device 1624 performs at least operation 1642 to collect information (e.g., device addresses) about the available devices in the intra-device network. Using the collected information, the service person can identify at least one target device on which to perform diagnostics. For example, the service person identifies the devices 1602B and 1602C as target devices on which to perform diagnostics.

In the illustrated example of FIG. 16, the service device 1624 performs at least operation 1644 to perform diagnostics on the device 1602B. For example, the device 1602A relays one or more communications related to the diagnostics between the service device 1624 and the device 1602B. In the example of FIG. 16, the device 1602B performs at least operation 1646 to provide diagnostic results to the service device 1624. For example, the device 1602A relays one or more communications related to the diagnostic results between the device 1602B and the service device 1624. Additionally, the service device 1624 performs at least operation 1648 to perform diagnostics on the device 1602C. For example, the device 1602A relays one or more communications related to the diagnostics between the service device 1624 and the device 1602C. In the example of FIG. 16, the device 1602C performs at least operation 1650 to provide diagnostic results to the service device 1624. For example, the device 1602A relays one or more communications related to the diagnostic results between the device 1602C and the service device 1624.

Modifications are possible in the described examples, and other examples are possible, within the scope of the claims.

From the foregoing, it will be appreciated that example systems, apparatus, articles of manufacture, and methods have been described that operate meters in multiple types of networks. Described systems, apparatus, articles of manufacture, and methods share or leverage common information to aid with network managements. For example, cellularly connected meters operate as provisioner devices for, and gateway devices of BLE mesh networks. Described examples include an example BLE mesh-to-cellular bridge for smart metering that simplifies data collection and improves reliability and robustness for metering. Also, examples described herein seamlessly integrate meters without cellular connectivity using BLE mesh networking. Described systems, apparatus, articles of manufacture, and methods improve the efficiency of using a computing device by minimizing the downtime of a meter by self-healing networks when a setup management device loses cellular connectivity. Described systems, apparatus, articles of manufacture, and methods are also directed to one or more improvement(s) in the operation of a machine such as a computer or other electronic, electromechanical, or mechanical device.

What is claimed is:

1. A device comprising:
a first transceiver for a first type of network;
a second transceiver for a second type of network; and
at least one processor core coupled to the first transceiver and the second transceiver, the at least one processor core configurable to, responsive to determining that the device may operate in the first type of network and the second type of network:
receive, via the first transceiver, a message of the first type of network; and
transmit, via the second transceiver, the message.

2. The device of claim 1, wherein one or more of the at least one processor core is configurable to adapt a role and operation of the device in the first type of network based on connectivity to the second type of network.

3. The device of claim 1, wherein one or more of the at least one processor core is configurable to:
assign a device address to a participant device of the first type of network; and
transmit, via the second transceiver, the device address.

4. The device of claim 3, wherein the device address includes an internet protocol address of the device and a port number of the device to which the participant device is assigned.

5. The device of claim 1, wherein the message is a first message, and one or more of the at least one processor core is configurable to:
receive, via the second transceiver, a second message; and
transmit, via the first transceiver, the second message to a participant device responsive to determining that the second message includes a device address assigned to the participant device.

6. The device of claim 1, wherein one or more of the at least one processor core is configurable to:
periodically transmit, via the first transceiver, heartbeat messages to a first participant device of the first type of network;
responsive to losing connectivity to the second type of network, cease communication, via the first transceiver, of the heartbeat messages to the first participant device; and
transmit, via the first transceiver, non-configured advertisement into a physical area around the device to join the first type of network as a second participant device.

7. The device of claim 1, wherein the message is a first message, and one or more of the at least one processor core is configurable to:
receive, via the first transceiver, periodic heartbeat messages from a participant device; and
responsive to failing to receive a threshold number of heartbeat messages, transmit, via the second transceiver, a second message, the second message to indicate that the participant device has lost connectivity.

8. The device of claim 1, wherein one or more of the at least one processor core is configurable to:
periodically transmit, via the first transceiver, advertisement messages for an intra-device network, the advertisement messages including a device address of the device and a network key for the intra-device network; and
at least one of respond to a service message from a service device or relay the service message to a target participant device, the service message including a target device address of the target participant device.

9. A meter comprising:
a transceiver; and
at least one processor core coupled to the transceiver, the at least one processor core configurable to:
monitor, via the transceiver, a first device for periodic heartbeat messages; and
responsive to failing to receive a threshold number of the heartbeat messages, transmit, via the transceiver, a non-configured advertisement to join a network via a second device.

10. The meter of claim 9, wherein the network is a first type of network, and one or more of the at least one processor core is configurable to adapt a role and operation of the meter in the first type of network based on connectivity to a second type of network.

11. The meter of claim 9, wherein the non-configured advertisement indicates that the meter is not in communication with the network.

12. The meter of claim 9, wherein the non-configured advertisement is a first non-configured advertisement, and one or more of the at least one processor core is configurable to:
transmit, via the transceiver, a second non-configured advertisement; and
responsive to determining that the second non-configured advertisement has been acknowledged by the first device, receive, via the transceiver, a message from the first device, the message including a group address of the first device, a device address of the meter, and a network key for the meter.

13. The meter of claim 9, wherein one or more of the at least one processor core is configurable to:
monitor, via the transceiver, the first device for a message; and
access, via the transceiver, the message responsive to determining that the message includes a device address assigned to the meter.

14. The meter of claim 13, wherein the device address includes an internet protocol address of the first device and a port number of the first device to which the meter is assigned.

15. The meter of claim 9, wherein the heartbeat messages are first heartbeat messages, and one or more of the at least one processor core is configurable to periodically transmit, via the transceiver, second heartbeat messages to the first device.

16. A method comprising:
responsive to determining that a device is capable of operating in a first type of network and a second type of network:
receiving, via a second transceiver over the second type of network, a message to manage the first type of network; and
transmitting, via a first transceiver over the first type of network, the message to a participant device of the first type of network responsive to determining that the message includes a device address assigned to the participant device.

17. The method of claim 16, including adapting a role and operation of the device in the first type of network based on connectivity to the second type of network.

18. The method of claim 16, including:
assigning the device address to the participant device; and
communicating, via the second type of network, the device address.

19. The method of claim 16, wherein the device address includes an internet protocol address of the device and a port number of the device to which the participant device is assigned.

20. The method of claim 16, wherein the message is a first message, and the method includes:
receiving, via the first type of network, a second message from the participant device; and
transmitting, via the second type of network, the second message.
